(19) United States
(12) Patent Application Publication
(10) Pub. No.: US 2021/0045409 A1
(43) Pub. Date: Feb. 18, 2021

(54) FAT DELIVERY SYSTEM, FAT DELIVERY METHOD AND FOOD PRODUCT CONTAINING THE FAT DELIVERY SYSTEM

(71) Applicant: Givaudan S.A., Vernier (CH)

(72) Inventors: Frans WITTEVEEN, Leusden (NL); Roy Methorst, Teteringen (NL)

(21) Appl. No.: 16/985,000

(22) Filed: Aug. 4, 2020

Related U.S. Application Data
(60) Provisional application No. 62/886,200, filed on Aug. 13, 2019.

(51) Int. Cl. A23J 3/22; A23P 20/25; A23L 35/00; A23P 30/25; A21D 13/32

(52) U.S. Cl. CPC A23J 3/227; A23P 20/25; A23V 2002/00; A23P 30/25; A21D 13/32; A23L 35/10

(57) ABSTRACT

A fat delivery system includes particles of at least one emulsified fat at least partially encapsulated in gelled material. A food product includes a plant-based protein base and a plurality of fat delivery particles dispersed within the plant-based protein base. The food product may be a plant-based meat analogue that approximates the appearance, flavor and texture of certain meat products. Methods for making the fat delivery particles and the food product are also disclosed.

### CROSS REFERENCE TO RELATED APPLICATIONS

This application claims the benefit of the filing date under 35 U.S.C. § 119(e) from U.S. Provisional Application For Patent Ser. No. 62/886,200, filed on Aug. 13, 2019, which is hereby incorporated by reference in its entirety.

### TECHNICAL FIELD

The present disclosure is directed to a fat delivery system, a method for preparing a fat delivery system, a food product containing the fat delivery system, and a method for preparing the food product containing the fat delivery system.

### BACKGROUND

A meat analogue is a food product that approximates the aesthetic properties (for example, appearance, flavor, and texture), chemical characteristics and cooking properties of certain types of meat. Meat analogues are also referred to in the food industry as animal protein analogues, meat alternatives, meat substitutes, mock meat, faux meat, imitation meat, vegetarian meat or vegan meat. Meat analogues are increasingly desired by health-conscious non-vegetarians, vegetarians, vegans, persons following religious dietary restrictions, persons seeking reduction of fat in their diet, persons seeking to reduce or eliminate consumption of processed real meat, others seeking to reduce consumption of meat for other ethical or nutritional reasons, and to achieve the reduction of fat while maintaining the same fat perception.

### SUMMARY

Disclosed is a fat delivery system comprising at least one emulsified fat and at least one gelled carbohydrate. According to certain embodiments, the at least one emulsified fat is at least partially encapsulated within the at least one gelled carbohydrate.

According to certain embodiments, the fat delivery system comprises at least one emulsified fat and at least one gelled starch. According to certain embodiments, the at least one emulsified fat is at least partially encapsulated within the at least one gelled starch.

According to certain embodiments, the fat delivery comprises at least one emulsified non-animal fat and at least one gelled carbohydrate. According to certain embodiments, the at least one emulsified non-animal fat is at least partially encapsulated within the at least one gelled carbohydrate.

According to certain embodiments, the fat delivery comprises at least one emulsified non-animal fat and at least one gelled starch. According to certain embodiments, the at least one emulsified non-animal fat is at least partially encapsulated within the at least one gelled starch.

According to certain embodiments, the fat delivery comprises at least one emulsified plant-derived fat and at least one gelled carbohydrate. According to certain embodiments, the at least one emulsified plant-derived fat is at least partially encapsulated within the at least one gelled carbohydrate.

According to certain embodiments, the fat delivery comprises at least one emulsified plant-derived fat and at least one gelled starch. According to certain embodiments, the at least one emulsified plant-derived fat is at least partially encapsulated within the at least one gelled starch.

According to certain embodiments, the fat delivery comprises at least one emulsified animal-derived fat and at least one gelled carbohydrate. According to certain embodiments, the at least one emulsified animal-derived fat is at least partially encapsulated within the at least one gelled carbohydrate.

According to certain embodiments, the fat delivery comprises at least one emulsified animal-derived fat and at least one gelled starch. According to certain embodiments, the at least one emulsified animal-derived fat is at least partially encapsulated within the at least one gelled starch.

According to certain embodiments, the fat delivery comprises an emulsified fat comprising a blend of at least one non-animal fat and at least one animal-derived fat, and at least one gelled carbohydrate. According to certain embodiments, the emulsified fat blend is at least partially encapsulated within the at least one gelled carbohydrate.

According to certain embodiments, the fat delivery comprises an emulsified fat comprising a blend of at least one non-animal fat and at least one animal-derived fat, and at least one gelled starch. According to certain embodiments, the emulsified fat blend is at least partially encapsulated within the at least one gelled starch.

According to certain embodiments, the fat delivery comprises an emulsified fat comprising a blend of at least one plant-derived fat and at least one animal-derived fat, and at least one gelled carbohydrate. According to certain embodiments, the emulsified fat blend is at least partially encapsulated within the at least one gelled carbohydrate.

According to certain embodiments, the fat delivery comprises an emulsified fat comprising a blend of at least one plant-derived fat and at least one animal-derived fat, and at least one gelled starch. According to certain embodiments, the emulsified fat blend is at least partially encapsulated within the at least one gelled starch.

According to certain embodiments, disclosed is a fat delivery system comprising from about 5 weight percent to about 95 weight percent of at least one emulsified fat and from about 5 weight percent to about 95 weight percent of at least one gelled carbohydrate, based on the total weight of the fat delivery system.

According to certain embodiments, disclosed is a fat delivery system comprising from about 5 weight percent to about 95 weight percent of at least one emulsified fat and from about 5 weight percent to about 95 weight percent of at least one gelled starch, based on the total weight of the fat delivery system.

According to certain embodiments, the fat delivery system comprises from about 5 weight percent to about 95 weight percent of at least one emulsified non-animal fat and from about 5 weight percent to about 95 weight percent of at least one gelled starch, based on the total weight of the fat delivery system.

According to certain embodiments, the fat delivery system comprises from about 5 weight percent to about 95 weight percent of at least one emulsified plant-derived fat and from about 5 weight percent to about 95 weight percent of at least one gelled starch, based on the total weight of the fat delivery system.

According to certain embodiments, the fat delivery system comprises from about 5 weight percent to about 95 weight percent of at least one emulsified animal-derived fat and from about 5 weight percent to about 95 weight percent of at least one gelled starch, based on the total weight of the fat delivery system.

According to certain embodiments, the fat delivery system comprises from about 5 weight percent to about 95 weight percent of an emulsified fat comprising a blend of at least one animal-derived fat and at least one non-animal fat, and from about 5 weight percent to about 95 weight percent of at least one gelled starch, based on the total weight of the fat delivery system.

According to certain embodiments, the fat delivery system comprises from about 5 weight percent to about 95 weight percent of an emulsified fat comprising a blend of at least one animal-derived fat and at least one plant-derived fat, and from about 5 weight percent to about 95 weight percent of at least one gelled starch, based on the total weight of the fat delivery system.

Additionally disclosed is a food product comprising an edible base, and a plurality of fat delivery systems dispersed within said edible base, wherein the fat delivery systems comprise particles of emulsified fat and gelled carbohydrate.

According to certain embodiments, the food product comprising an edible base, and a plurality of fat delivery systems dispersed within said edible base, wherein the fat delivery systems comprise particles of emulsified fat and gelled starch.

According to certain embodiments, the food product comprises an edible base, and a plurality of fat delivery systems dispersed within said edible base, wherein the fat delivery systems comprise particles of emulsified fat at least partially encapsulated by a gelled carbohydrate.

According to certain embodiments, the food product comprises an edible base, and a plurality of fat delivery systems dispersed within said edible base, wherein the fat delivery systems comprise particles of emulsified fat at least partially encapsulated by a gelled starch.

According to certain embodiments, the food product comprising an edible protein base, and a plurality of fat delivery systems dispersed within said edible protein base, wherein the fat delivery systems comprise particles of an emulsified fat and gelled carbohydrate.

According to certain embodiments, the food product comprising an edible protein base, and a plurality of fat delivery systems dispersed within said edible protein base, wherein the fat delivery systems comprise particles of an emulsified fat and gelled starch.

According to certain embodiments, the food product comprises an edible protein base, and a plurality of fat delivery systems dispersed within said edible protein base, wherein the fat delivery systems comprise particles of emulsified fat at least partially encapsulated by a gelled carbohydrate.

According to certain embodiments, the food product comprises an edible protein base, and a plurality of fat delivery systems dispersed within said edible protein base, wherein the fat delivery systems comprise particles of emulsified fat at least partially encapsulated by a gelled starch.

According to certain embodiments, the food product comprises an edible protein base, and a plurality of fat delivery systems dispersed within said edible protein base, wherein the fat delivery systems comprise particles of an emulsified non-animal fat and gelled carbohydrate.

According to certain embodiments, the food product comprises an edible protein base, and a plurality of fat delivery systems dispersed within said edible protein base, wherein the fat delivery systems comprise particles of an emulsified non-animal fat and gelled starch.

According to certain embodiments, the food product comprises an edible protein base, and a plurality of fat delivery systems dispersed within said edible protein base, wherein the fat delivery systems comprise particles of emulsified non-animal fat at least partially encapsulated by a gelled carbohydrate.

According to certain embodiments, the food product comprises an edible protein base, and a plurality of fat delivery systems dispersed within said edible protein base, wherein the fat delivery systems comprise particles of emulsified non-animal fat at least partially encapsulated by a gelled starch.

According to certain embodiments, the food product comprises an edible protein base, and a plurality of fat delivery systems dispersed within said edible protein base, wherein the fat delivery systems comprise particles of an emulsified plant-derived fat and gelled carbohydrate.

According to certain embodiments, the food product comprises an edible protein base, and a plurality of fat delivery systems dispersed within said edible protein base, wherein the fat delivery systems comprise particles of an emulsified plant-derived fat and gelled starch.

According to certain embodiments, the food product comprises an edible protein base, and a plurality of fat delivery systems dispersed within said edible protein base, wherein the fat delivery systems comprise particles of emulsified plant-derived fat at least partially encapsulated by a gelled carbohydrate.

According to certain embodiments, the food product comprises an edible protein base, and a plurality of fat delivery systems dispersed within said edible protein base, wherein the fat delivery systems comprise particles of emulsified plant-derived fat at least partially encapsulated by a gelled starch.

According to certain embodiments, the food product comprises an edible protein base, and a plurality of fat delivery systems dispersed within said edible protein base, wherein the fat delivery systems comprise particles of emulsified fat comprising a blend of at least one animal and at least one plant-derived fat and gelled carbohydrate.

According to certain embodiments, the food product comprises an edible protein base, and a plurality of fat delivery systems dispersed within said edible protein base, wherein the fat delivery systems comprise particles of emulsified fat comprising a blend of at least one animal and at least one plant-derived fat and gelled starch.

According to certain embodiments, the food product comprises an edible protein base, and a plurality of fat delivery systems dispersed within said edible protein base, wherein the fat delivery systems comprise particles of emulsified comprising a blend of at least one animal fat and at least one plant-derived fat at least partially encapsulated by a gelled carbohydrate.

According to certain embodiments, the food product comprises an edible protein base, and a plurality of fat delivery systems dispersed within said edible protein base, wherein the fat delivery systems comprise particles of emulsified comprising a blend of at least one animal fat and at least one plant-derived fat at least partially encapsulated by a gelled starch.

According to certain embodiments, the food product comprises an edible non-animal protein base, and a plurality of fat delivery systems dispersed within said edible non-animal protein base, wherein the fat delivery systems comprise particles of an emulsified fat and gelled carbohydrate.

According to certain embodiments, the food product comprises an edible non-animal protein base, and a plurality of fat delivery systems dispersed within said edible non-animal protein base, wherein the fat delivery systems comprise particles of an emulsified fat and gelled starch.

According to certain embodiments, the food product comprises an edible plant-derived protein base, and a plurality of fat delivery systems dispersed within said edible plant-derived protein base, wherein the fat delivery systems comprise particles of an emulsified fat and gelled carbohydrate.

According to certain embodiments, the food product comprises an edible plant-derived protein base, and a plurality of fat delivery systems dispersed within said edible plant-derived protein base, wherein the fat delivery systems comprise particles of an emulsified fat and gelled starch.

According to certain embodiments, the food product comprises an edible plant-derived protein base, and a plurality of fat delivery systems dispersed within said edible plant-derived protein base, wherein the fat delivery systems comprise particles of an emulsified fat at least partially encapsulated by a gelled carbohydrate.

According to certain embodiments, the food product comprises an edible plant-derived protein base, and a plurality of fat delivery systems dispersed within said edible plant-derived protein base, wherein the fat delivery systems comprise particles of an emulsified fat at least partially encapsulated by a gelled starch.

According to certain embodiments, the food product comprises an edible animal-derived protein base, and a plurality of fat delivery systems dispersed within said edible animalderived protein base, wherein the fat delivery systems comprise particles of an emulsified fat and gelled carbohydrate.

According to certain embodiments, the food product comprises an edible animal-derived protein base, and a plurality of fat delivery systems dispersed within said edible animalderived protein base, wherein the fat delivery systems comprise particles of an emulsified fat and gelled starch.

According to certain embodiments, the food product comprises an edible animal-derived protein base, and a plurality of fat delivery systems dispersed within said edible animal-derived protein base, wherein the fat delivery systems comprise particles of an emulsified fat at least partially encapsulated by a gelled carbohydrate.

According to certain embodiments, the food product comprises an edible animal-derived protein base, and a plurality of fat delivery systems dispersed within said edible animal-derived protein base, wherein the fat delivery systems comprise particles of an emulsified fat at least partially encapsulated by a gelled starch.

According to certain embodiments, the food product comprises an edible protein base comprising a blend of at least one animal-derived protein and at least one plant-derived protein, and a plurality of fat delivery systems dispersed within said edible protein base, wherein the fat delivery systems comprise particles of an emulsified fat and gelled carbohydrate.

According to certain embodiments, the food product comprises an edible protein base comprising a blend of at least one animal-derived protein and at least one plant-derived protein, and a plurality of fat delivery systems dispersed within said edible protein base, wherein the fat delivery systems comprise particles of an emulsified fat and gelled starch.

According to certain embodiments, the food product comprises an edible protein base comprising a blend of at least one animal-derived protein and at least one plant-derived protein, and a plurality of fat delivery systems dispersed within said edible protein base, wherein the fat delivery systems comprise particles of the emulsified fat at least partially encapsulated by a gelled carbohydrate.

According to certain embodiments, the food product comprises an edible protein base comprising a blend of at least one animal-derived protein and at least one plant-derived protein, and a plurality of fat delivery systems dispersed within said edible protein base, wherein the fat delivery systems comprise particles of the emulsified fat at least partially encapsulated by a gelled starch.

Further disclosed is a method for preparing a fat delivery system comprising emulsifying at least one fat, gelling at least one carbohydrate and at least partially encapsulating the emulsified fat with the gelled carbohydrate.

According to certain embodiments, the method for preparing a fat delivery system comprises emulsifying at least one fat, gelling at least one starch and at least partially encapsulating the emulsified fat with the gelled starch.

According to certain embodiments, the method for preparing a fat delivery system comprises emulsifying at least one non-animal fat, gelling at least one carbohydrate and at least partially encapsulating the emulsified fat with the gelled carbohydrate.

According to certain embodiments, the method for preparing a fat delivery system comprises emulsifying at least plant-derived fat, gelling at least one carbohydrate and at least partially encapsulating the emulsified fat with the gelled carbohydrate.

According to certain embodiments, the method for preparing a fat delivery system comprises emulsifying at least one non-animal fat, gelling at least one starch and at least partially encapsulating the emulsified fat with the gelled starch.

According to certain embodiments, the method for preparing a fat delivery system comprises emulsifying at least plant-derived fat, gelling at least one starch and at least partially encapsulating the emulsified fat with the gelled starch.

According to certain embodiments, the method for preparing a fat delivery system comprises emulsifying at least one animal-derived fat, gelling at least one starch and at least partially encapsulating the emulsified fat with the gelled starch.

According to certain embodiments, the method for preparing a fat delivery system comprises emulsifying at least one plant-derived fat and at least one animal-derived fat to create an emulsified fat blend, gelling at least one carbohydrate and at least partially encapsulating the emulsified fat blend with the gelled carbohydrate.

According to certain embodiments, the method for preparing a fat delivery system comprises emulsifying at least one plant-derived fat and at least one animal-derived fat to create an emulsified fat blend, gelling at least one starch and at least partially encapsulating the emulsified fat blend with the gelled starch.

According to certain embodiments, the method for preparing the fat delivery system comprises forming an emulsion with at least one fat and water, adding at least one starch to the emulsion, at least partially gelling the at least one carbohydrate, and forming a solid from the emulsion containing the gelled carbohydrate.

According to certain embodiments, the method for preparing the fat delivery system comprises forming an emulsion with at least one fat and water, adding at least one starch to the emulsion, at least partially gelling the at least one starch, and forming a solid from the emulsion containing the gelled starch.

According to certain embodiments, the method for preparing a fat delivery system comprises forming an emulsion with at least one non-animal fat and water, adding at least one carbohydrate to the emulsion, at least partially gelling the at least one carbohydrate, and forming a solid from the emulsion containing the gelled carbohydrate.

According to certain embodiments, the method for preparing a fat delivery system comprises forming an emulsion with at least one plant-derived fat and water, adding at least one carbohydrate to the emulsion, at least partially gelling the at least one carbohydrate, and forming a solid from the emulsion containing the gelled carbohydrate.

According to certain embodiments, the method for preparing a fat delivery system comprises forming an emulsion with at least one plant-derived fat, at least one animal-derived fat and water, adding at least one carbohydrate to the emulsion, at least partially gelling the at least one carbohydrate, and forming a solid from the emulsion containing the gelled carbohydrate.

According to certain embodiments, the method for preparing a fat delivery system comprising forming an emulsion with at least one fat and water, adding at least one carbohydrate to the emulsion, at least partially gelling the at least one carbohydrate, and at least partially encapsulating the fat emulsion with the gelled carbohydrate.

According to certain embodiments, the method for preparing a fat delivery system comprising forming an emulsion with at least one fat and water, adding at least one starch to the emulsion, at least partially gel the at least one starch, and at least partially encapsulating the fat emulsion with the gelled starch.

According to certain embodiments, the method for preparing a fat delivery system comprises forming an emulsion with at least one non-animal fat and water, adding at least one starch to the emulsion, at least partially gelling the at least one starch, and at least partially encapsulating the fat emulsion with the gelled starch.

According to certain embodiments, the method for preparing a fat delivery system comprises forming an emulsion with at least one plant-derived fat and water, adding at least one starch to the emulsion, at least partially gelling the at least one starch, and at least partially encapsulating the fat emulsion with the gelled starch.

According to certain embodiments, the method for preparing a fat delivery system comprises forming an emulsion with at least one plant-derived fat, at least one animal-derived fat and water, adding at least one starch to the emulsion, at least partially gelling the at least one starch, and at least partially encapsulating the fat emulsion with the gelled starch.

According to certain embodiments, the method for preparing a fat delivery system comprises heating a fat, mixing a carbohydrate with the heated fat to form a mixture, adding water to the mixture to form an emulsion, heating the emulsion to at least partially gel the at least one carbohydrate, and cooling the mixture to form a solid fat delivery system from the emulsion and the at least partially gelled carbohydrate.

According to certain embodiments, the method for preparing a fat delivery system comprises heating a fat, mixing a starch with the heated fat to form a mixture, adding water to the mixture to form an emulsion, heating the emulsion to at least partially gel the at least one starch, and cooling the mixture to form a solid fat delivery system from the emulsion containing the gelled starch.

According to certain embodiments, the method for preparing a fat delivery system comprises heating a non-animal fat, mixing a starch with the heated non-animal fat to form a mixture, adding water to the mixture to form an emulsion, heating the emulsion to at least partially gel the at least one starch, and cooling the mixture to form a solid fat delivery system from the emulsion and the gelled starch.

According to certain embodiments, the method for preparing a fat delivery system comprises heating a plant-derived fat, mixing a starch with the heated plant-derived fat to form a mixture, adding water to the mixture to form an emulsion, heating the emulsion to at least partially gel the at least one starch, and cooling the mixture to form a solid fat delivery system from the emulsion and the gelled starch.

According to certain embodiments, then method for preparing a fat delivery system comprises heating a animal fat, mixing a starch with the heated animal fat to form a mixture, adding water to the mixture to form an emulsion, heating the emulsion to at least partially gel the at least one starch, and cooling the mixture to form a solid fat delivery system from the emulsion and the gelled starch.

According to certain embodiments, then method for preparing a fat delivery system comprises heating at least one animal fat and at least one plant-derived fat to form a blend of heated fat, mixing a starch with the heated blend of fat to form a mixture, adding water to the mixture to form an emulsion, heating the emulsion to at least partially gel the at least one starch, and cooling the mixture to form a solid fat delivery system from the emulsion containing the gelled starch.

According to certain embodiments, then method for preparing a fat delivery system comprises heating a non-animal fat, mixing a carbohydrate with the heated non-animal fat to form a mixture, adding water to the mixture to form an emulsion, heating the emulsion to at least partially gel the at least one carbohydrate, and cooling the mixture to at least partially encapsulate the fat emulsion with the gelled carbohydrate.

According to certain embodiments, then method for preparing a fat delivery system comprises heating a non-animal fat, mixing a starch with the heated non-animal fat to form a mixture, adding water to the mixture to form an emulsion, heating the emulsion to at least partially gel the at least one starch, and cooling the mixture to at least partially encapsulate the fat emulsion with the gelled starch.

According to certain embodiments, then method for preparing a fat delivery system comprises heating a plant-derived fat, mixing a starch with the heated plant-derived fat to form a mixture, adding water to the mixture to form an emulsion, heating the emulsion to at least partially gel the at least one starch, and cooling the mixture to at least partially encapsulate the fat emulsion with the gelled starch.

According to certain embodiments, then method for preparing a fat delivery system comprises heating a animal fat, mixing a starch with the heated animal fat to form a mixture, adding water to the mixture to form an emulsion, heating the emulsion to at least partially gel the at least one starch, and cooling the mixture to at least partially encapsulate the fat emulsion with the gelled starch.

According to certain embodiments, then method for preparing a fat delivery system comprises heating at least one animal fat and at least one plant-derived fat to form a blend of heated fat, mixing a starch with the heated blend of fat to form a mixture, adding water to the mixture to form an emulsion, heating the emulsion to at least partially gel the at least one starch, and cooling the mixture to at least partially encapsulate the fat emulsion with the gelled starch.

According to certain embodiments, then method for preparing a fat delivery system comprises heating a non-animal fat, mixing a carbohydrate with the heated non-animal fat to form a mixture, adding water to the mixture to form an emulsion, heating the emulsion by direct steam injection to at least partially gel the at least one carbohydrate, and cooling the mixture to form a solid fat delivery system from the emulsion and the gelled carbohydrate.

According to certain embodiments, then method for preparing a fat delivery system comprises heating a non-animal fat, mixing a starch with the heated non-animal fat to form a mixture, adding water to the mixture to form an emulsion, heating the emulsion by direct steam injection to at least partially gel the at least one starch, and cooling the mixture to form a solid fat delivery system from the emulsion and the gelled starch.

According to certain embodiments, then method for preparing a fat delivery system comprises heating a plant-derived fat, mixing a carbohydrate with the heated plant-derived fat to form a mixture, adding water to the mixture to form an emulsion, heating the emulsion by direct steam injection to at least partially gel the at least one carbohydrate, and cooling the mixture to form a solid fat delivery system from the emulsion and the gelled starch.

According to certain embodiments, then method for preparing a fat delivery system comprises heating a plant-derived fat, mixing a starch with the heated plant-derived fat to form a mixture, adding water to the mixture to form an emulsion, heating the emulsion by direct steam injection to at least partially gel the at least one starch, and cooling the mixture to form a solid fat delivery system from the emulsion containing the gelled starch.

According to certain embodiments, then method for preparing a fat delivery system comprises heating at least one plant-derived fat and at least one animal-derived fat to created a heated fat blend, mixing a starch with the heated fat blend to form a mixture, adding water to the mixture to form an emulsion, heating the emulsion by direct steam injection to at least partially gel the at least one starch, and cooling the mixture to form a solid fat delivery system from the emulsion containing the gelled starch.

According to certain embodiments, then method for preparing a fat delivery system comprises heating a non-animal fat, mixing a carbohydrate with the heated non-animal fat to form a mixture, adding water to the mixture to form an emulsion, heating the emulsion by direct steam injection to at least partially gel the at least one carbohydrate, and at least partially encapsulating the fat emulsion with the gelled carbohydrate.

According to certain embodiments, then method for preparing a fat delivery system comprises heating a plant-derived fat, mixing a carbohydrate with the heated plant-derived fat to form a mixture, adding water to the mixture to form an emulsion, heating the emulsion by direct steam injection to at least partially gel the at least one carbohydrate, and at least partially encapsulating the fat emulsion with the gelled carbohydrate.

According to certain embodiments, then method for preparing a fat delivery system comprises heating a non-animal fat, mixing a starch with the heated non-animal fat to form a mixture, adding water to the mixture to form an emulsion, heating the emulsion by direct steam injection to at least partially gel the at least one starch, and at least partially encapsulating the fat emulsion with the gelled starch.

According to certain embodiments, then method for preparing a fat delivery system comprises heating a plant-derived fat, mixing a starch with the heated plant-derived fat to form a mixture, adding water to the mixture to form an emulsion, heating the emulsion by direct steam injection to at least partially gel the at least one starch, and at least partially encapsulating the fat emulsion with the gelled starch.

According to certain embodiments, then method for preparing a fat delivery system comprises heating at least one plant-derived fat and at least one animal-derived fat to create a heated fat blend, mixing a starch with the heated fat blend to form a mixture, adding water to the mixture to form an emulsion, heating the emulsion by direct steam injection to at least partially gel the at least one starch, and at least partially encapsulating the fat emulsion with the gelled starch.

Further disclosed is a method for making a food product comprising mixing together an edible protein base and a plurality of fat delivery systems together to form a mixture, wherein the fat delivery systems comprise solid particles of an emulsified fat and gelled carbohydrate, and forming the mixture into a solid.

According to certain embodiments, the method for making a food product comprises mixing together an edible protein base and a plurality of fat delivery systems together to form a mixture, wherein the fat delivery systems comprise solid particles of an emulsified fat at least partially encapsulated with a gelled carbohydrate, and forming the mixture into a solid.

According to certain embodiments, the method for making a food product comprises mixing together an edible protein base and a plurality of fat delivery systems together to form a mixture, wherein the fat delivery systems comprise solid particles of an emulsified fat at least partially encapsulated with a gelled starch, and forming the mixture into a solid.

According certain embodiments, the method for making a food product comprises mixing together an edible protein base and a plurality of fat delivery systems together to form a mixture, wherein the fat delivery systems comprise solid particles of an emulsified fat and gelled starch, and forming the mixture into a solid.

According to certain embodiments, the method for making a food product comprises mixing together an edible plant-based protein base and a plurality of fat delivery systems together to form a mixture, wherein the fat delivery systems comprise solid particles of an emulsified fat and gelled carbohydrate, and forming the mixture into a solid.

According to certain embodiments, the method for making a food product comprises mixing together an edible plant-based protein base and a plurality of fat delivery systems together to form a mixture, wherein the fat delivery systems comprise solid particles of an emulsified fat and gelled starch, and forming the mixture into a solid.

According to certain embodiments, the method for making a food product comprises mixing together an edible animal-based protein base and a plurality of fat delivery systems together to form a mixture, wherein the fat delivery systems comprise solid particles of an emulsified fat and gelled carbohydrate, and forming the mixture into a solid.

According to certain embodiments, the method for making a food product comprises mixing together an edible animal-based protein base and a plurality of fat delivery systems together to form a mixture, wherein the fat delivery systems comprise solid particles of an emulsified fat and gelled starch, and forming the mixture into a solid.

According to certain embodiments, the method for making a food product comprises mixing together an edible protein base comprising a blend of an edible plant-derived protein base and an animal derived protein base and a plurality of fat delivery systems together to form a mixture, wherein the fat delivery systems comprise solid particles of an emulsified fat and gelled carbohydrate, and forming the mixture into a solid.

According to certain embodiments, the method for making a food product comprises mixing together an edible protein base comprising a blend of an edible plant-derived protein base and an animal derived protein base and a plurality of fat delivery systems together to form a mixture, wherein the fat delivery systems comprise solid particles of an emulsified fat and gelled starch, and forming the mixture into a solid.

According to certain embodiments, the method for making a food product comprises mixing together an edible plant-based protein base and a plurality of fat delivery systems together to form a mixture, wherein the fat delivery systems comprise solid particles of an emulsified non-animal fat and gelled carbohydrate, and forming the mixture into a solid.

According to certain embodiments, the method for making a food product comprises mixing together an edible plant-based protein base and a plurality of fat delivery systems together to form a mixture, wherein the fat delivery systems comprise solid particles of an emulsified non-animal fat and gelled starch, and forming the mixture into a solid.

According to certain embodiments, the method for making a food product comprises mixing together an edible plant-based protein base and a plurality of fat delivery systems together to form a mixture, wherein the fat delivery systems comprise solid particles of an emulsified plant-derived fat and gelled carbohydrate, and forming the mixture into a solid.

According to certain embodiments, the method for making a food product comprises mixing together an edible plant-based protein base and a plurality of fat delivery systems together to form a mixture, wherein the fat delivery systems comprise solid particles of an emulsified plant-derived fat and gelled starch, and forming the mixture into a solid.

### BRIEF DESCRIPTION OF THE DRAWINGS

FIG. 1A is a photograph of an illustrative embodiment of a vegetarian meat analogue of the present disclosure prior to cooking.

FIG. 1B is a photograph of the illustrative embodiment of a vegetarian meat analogue of the present disclosure after cooking by frying.

FIG. 2 is a photograph of an illustrative embodiment of the meat analogue in the form of a round burger patty before the cooking process.

FIG. 3 is a photograph showing a cross section of an illustrative embodiment of the meat analogue in the form of a round burger patty before the cooking process.

FIG. 4 is a photograph of an illustrative embodiment of the meat analogue in the form of a round burger patty during the cooking process.

FIG. 5 is a photograph showing a cross section of an illustrative embodiment of the meat analogue in the form of a round burger patty after the cooking process.

FIGS. 6A and 6B are photographs showing an illustrative embodiment of the meat analogue in the form of an elongated sausage.

FIG. 7 is a photograph showing a longitudinal section of an illustrative embodiment of the meat analogue in the form of an elongated sausage.

FIG. 8 is a confocal scanning laser microscopy image taken from a solid block of an illustrative example of the fat delivery system.

### DETAILED DESCRIPTION

Fat delivery systems comprise an emulsified fat component and a gelled matrix material for at least partially encapsulating or entrapping the emulsified fat component. The emulsified fat component is at least partially encapsulated or entrapped within the gelled matrix material. A plurality of the fat delivery systems are dispersed throughout a food base to create a food product containing the fat delivery systems. The use of the fat delivery system can significantly reduce the total fat content in a meat analogue product or in a real meat product.

According to certain embodiments, the fat delivery system comprises an emulsified non-animal fat component and the matrix material has been at least partially gelled. The emulsified non-animal fat component is at least partially encapsulated or entrapped within the gelled matrix material. According to other embodiments, the non-animal fat delivery system comprises an emulsified non-animal fat component and the matrix material comprises a carbohydrate that has been at least partially gelled. The emulsified non-animal fat component is at least partially encapsulated or entrapped within the gelled carbohydrate material. According to other embodiments, the non-animal fat delivery system comprises an emulsified non-animal fat component and the matrix material comprises a starch that has been at least partially gelled. The emulsified non-animal fat component is at least partially encapsulated or entrapped within the gelled starch matrix material.

According to certain embodiments, the plurality of the fat delivery systems are dispersed throughout an edible food base to create an edible food product containing the fat delivery systems. According to certain embodiments, the plurality of the fat delivery systems are dispersed throughout a plant-based or vegetarian food base to create a plant-based food product containing the fat delivery systems. According to further illustrative embodiments, the plurality of the fat delivery systems containing the non-animal fat are dispersed throughout a plant-based or vegetarian protein base to create a meat analogue product containing the fat delivery systems. The appearance, flavor, and texture of the meat analogue product is similar to that of certain real meat products.

According to certain embodiments, the food product is a vegetarian food product. In other embodiments, the food product is a vegan food product containing only plant-derived components and no animal-derived components.

According to certain embodiments, the food product is a real meat food product that includes animal components. For example, and without limitation, the real meat food product may comprise real animal muscle meat, protein, or tissue, and a plurality of the fat delivery systems. According to certain embodiments, the food product may be a semi-solid or solid food product comprising an animal-derived muscle meat, protein, or tissue having a plurality of fat delivery systems containing a plant-derived fat dispersed within the muscle meat, protein or tissue.

According to other embodiments, the food product comprises a hybrid food product that contains a blend, combination, or mixture of at least one animal meat component and at least one non-animal meat analogue component, as the food base to which the fat delivery system is added. The food base of the hybrid food product may comprise both an animal protein component and a non-animal protein component. For example, the food base of the hybrid food product may comprise both an animal protein component and a non-animal, plant-based protein component. Without limitation, and only by way of example, the hybrid food product may comprise real animal muscle meat, protein, or tissue, and at least one plant-based protein, and a plurality of the fat delivery systems dispersed within the combination of the real meat component and the plant-based protein component. According to certain embodiments, the food product may be a semi-solid or solid food product comprising an animal-derived muscle meat, protein, or tissue, a plant-based, non-animal protein, and a plurality of fat delivery systems containing an emulsified fat such as an emulsified plant-derived fat.

According to other embodiments, the food product may comprise a cultured or cultivated real meat as the food base to which the fat delivery system is incorporated. A cultured or cultivated meat refers to a muscle meat product produced from culturing cells isolated from a living animal. A cultured meat is produced by first isolating cells from an animal, such as a cow, and culturing the cells in a controlled environment that mimics nature. During the process, the cells in the culture grow to produce a three-dimensional unit of muscle tissue, such as a steak. A desired amount of the fat delivery systems can be incorporated into the muscle tissue unit as it is being constructed from the cell culture. According to other embodiments, the produced unit of muscle tissue may be processed into another form and the fat delivery system can be incorporated into any modified form of the original muscle tissue to produce different edible foods products other than steaks.

According to certain embodiments, the food product is a product that can be considered to be a “clean-label” product. The “clean-label” movement is a consumer movement or trend driven by health and nutrition conscious consumers. The term “clean-label” is a term that has been adopted by the food industry, consumers, academics, and governmental regulatory agencies. A “clean-label” product is a food product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

The amount of fat present in the fat delivery system may be from about 5 to about 95 weight percent based on the total weight of the fat delivery system. According to certain illustrative embodiments, the amount of fat present in the fat delivery system may be from about 10 to about 60 weight percent, or from about 15 to about 60 weight percent, or from about 20 to about 60 weight percent, or from about 25 to about 60 weight percent, or from about 30 to about 60 weight percent, or from about 35 to about 60 weight percent, or from about 40 to about 60 weight percent, or from about 45 to about 60 weight percent, or from about 50 to about 60 weight percent, or from about 55 to about 60 weight percent, based on the total weight of the fat delivery system.

According to certain illustrative embodiments, the amount of fat in the fat delivery system may be from about 10 to about 50 weight percent, or from about 15 to about 50 weight percent, or from about 20 to about 50 weight percent, or from about 25 to about 50 weight percent, or from about 30 to about 50 weight percent, or from about 35 to about 50 weight percent, or from about 40 to about 50 weight percent, or from about 45 to about 50 weight percent, based on the total weight of the fat delivery system.

According to certain illustrative embodiments, the amount of fat in the fat delivery system may be from about 10 to about 40 weight percent, or from about 15 to about 40 weight percent, or from about 20 to about 40 weight percent, or from about 25 to about 40 weight percent, or from about 30 to about 40 weight percent, or from about 35 to about 40 weight percent based on the total weight of the fat delivery system.

According to certain illustrative embodiments, the amount of fat in the fat delivery system may be from about 10 to about 30 weight percent, or from about 15 to about 30 weight percent, or from about 20 to about 30 weight percent, or from about 25 to about 30 weight percent, based on the total weight of the fat delivery system.

The non-animal fat of the fat delivery system and food product may comprise solid fats, semi-solid fats, oils and combinations thereof.

According to certain embodiments, the fat that may constitute the fat component of the fat delivery systems comprises one or more fats that are solid or semi-solid at room temperature. According to other embodiments, the one or more solid or semi-solid fats of the fat delivery system comprises a non-animal fat. According to further embodiments, the one or more non-animal solid or semi-solid fats of the fat delivery system comprises a vegetable or plant-based fat that is semi-solid or solid at room temperature. The solid or semi-solid plant-based fat may comprise, without limitation, cocoa butter alternatives, cocoa butter equivalents, cocoa butter extenders, cocoa butter improvers, cocoa butter replacers, cocoa butter substitutes, coconut butter, palm butter, shea butter, modified vegetable fats, vegetable waxes, calorie-reduced fats, sugar-fatty acid ester fat substitutes (eg, sucrose ester fat substitutes such as Olestra™) and mixtures thereof. Non-animal-derived omega 3 and omega 6 fats may be used. Plant-derived omega 3 and omega 6 fats may be used. Vegan omega 3 and omega 6 fats can be used. Modified vegetable fats include Epogee™ commercially available from Epogee, LLC (Indianpolis, Ind., US). The Epogee™ fat replacer is based on alkoxylated rapeseed oil. Epogee™ is prepared by separating the glycerol and fatty acid components of the fat, inserting a propxyl group, and reconnecting the glycerol and fatty acid components through the propoxyl group.

For embodiments directed to real meat applications and products, and hybrid meat food applications and products, the fat component of fat delivery system may comprise at least one animal-derived fat and/or at least one plant-derived fat. The fat component of the fat delivery system may also include a combination of at least one animal-derived fat and at least one plant-derived fat. According to certain embodiments, when the fat component of the fat delivery system comprises a combination of at least one animal-derived fat and at least one plant-derived fat, there may be more of the at least one animal-based fat in the fat component of the fat delivery system as compared to the plant-derived fat. According to other embodiments, when the fat component of the fat delivery system comprises a combination of at least one animal-derived fat and at least one plant-derived fat, there may be more of the at least one plant-based fat in the fat component of the fat delivery system as compared to the animal-derived fat. Suitable animal fats include animal-derived butter fats, milk fats, lard, and the like. Without limitation, for example, the animalic fat may be derived from chicken, cow, duck, goose, pig and combinations thereof.

According to certain embodiments, the oils that may constitute the fat component of the fat delivery systems may comprise algal oils, insect oils, vegetable-derived oils and combinations. According to certain embodiments, the fat component of the fat delivery systems comprises one or more vegetable-derived oils. Without limitation, and only by way of illustration, suitable vegetable oils that may be used to prepare the fat delivery systems include almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof.

Without limitation, a suitable edible plant-based fat that can be used to prepare the fat delivery systems is commercially available under the trademark COBERINE® from IPI Loders Crocklaan (Malaysia). The COBERINE®-branded edible fats are considered cocoa butter equivalents and are based on coconut oil/fat, illipe oil, palm oil, shea oil, and mixtures thereof.

The fat delivery system includes a matrix material that covers, encapsulates or entraps the emulsified fat of the fat delivery system. According to certain embodiments, the matrix material includes a carbohydrate that has been at least partially gelled and which at least partially covers, encapsulates or entraps the emulsified fat of the fat delivery system. The fat delivery systems may include an edible starch as the matrix material for at least partially encapsulating or entrapping the emulsified fat within the matrix material. A starch is a complex carbohydrate which is composed of amylose and amylopectin units bonded together by glycosidic bonds to form starch granules. All native starches and certain modified starches may be used to prepare the fat delivery system. Useful starches include at least one grain starch, at least one root starch derived from root vegetables, and mixtures thereof. According to certain embodiments, the starch may be at least one grain starch. According to other embodiments, the starch may be at least one root starch. The starch included in the fat delivery system may be a starch termed in the art as a “waxy” starch. A waxy starch is a type of starch that contains a greater amount of the amylopectin fraction as compared to a regular starch. A waxy starch may comprise at least about 90 weight percent amylopectin, or at least 95 weight percent amylopectin, or even at least 97 weight percent amylopectin.

Specific starches that may be used to prepare the fat delivery systems include, without limitation, arrowroot starch, bean starch (such as, for example, fava beans, kidney beans, lentil beans, mung beans, and chickpeas), cassava starch, corn starch, oat starch, pea starch, potato starch (including both waxy potato starch and floury or mealy potato starch), quinoa, rice starch, tapioca starch, wheat starch, and mixtures thereof. According to certain embodiments, the starch is corn starch. According to certain embodiments, the starch is potato starch. According to certain embodiments, the starch is rice starch. According to certain embodiments, the starch is wheat starch. Suitable food grade potato starches are commercially available from Avebe (Veendam, The Netherlands) under the trademarks ELIANE™, ETENIA™, FARINEX™, PASELLI™, PERFECTAMYL™, and PURAMYL™.

According to some embodiments, one or more hydrocolloids may be used in combination with the starch, or as a replacement for the starch to prepare the fat delivery system. Suitable hydrocolloids include, without limitation, gums such as gelan gum, guar gum, tara gum, xanthan gum, locust bean gum and gum arabic, agarose, agar-agar, alginate, konjac, pectin, carrageenan, cellulose derivatives such carboxymethylcellulose and combinations thereof.

According to certain embodiments, one or more plant derived proteins may be used in combination with the starch, or as a replacement for the starch, to prepare the fat delivery system. For example, and without limitation, the plant-derived protein may comprise algae (such as spirulina), beans (such as black beans, canelli beans, kidney beans, lentil beans, lima beans, pinto beans, soy beans, white beans, mung beans), broccoli, mycoprotein, nuts (such as almonds, brazil nuts, cashews, peanuts, pecans, hazelnuts, pine nuts, walnuts), peas (such as black eyed peas, chickpeas, green peas), potatoes, seeds (such as canola, chia, flax, hemp, pumpkin, sesame, sunflower), plant leaf proteins such as Rubisco, cereal (such as oatmeal, wheat, barley, spelt), corn, rice and mixtures thereof.

The fat delivery systems may further include a sufficient amount of at least one flavor agent to impart a desired level of flavor or taste to the fat delivery systems. A single flavor agent or combinations of two or more flavor agents may be included in the fat delivery system to prepare a variety of plant-based food products having different flavors or tastes. Without limitation, and only by way of illustration, the flavor agents may include beef flavor, pork flavor, veal flavor, chicken flavor, duck flavor, goose flavor, lamb flavor, turkey flavor, fish flavor, seafood flavors (including, for example, lobster, clam, crab, mussel, scallop, shrimp, oyster) fruity flavors, seasonings, spices, herbs, sweet tastants, salty tastants, umami tastants, taste enhancers, taste modifiers, and the like. There may also be one or more acids present in the taste component to induce succulence and saliva production.

The fat delivery systems may further include a sufficient amount of at least one preservative for the fat delivery system to prevent decomposition and/or microbial growth. Illustrative preservatives include, without limitation, ascorbic acid, benzoic acid, butylated hydoxyanisole (BHA), butylated hydroxytoluene (BHT), citric acid, disodium ethylenediaminetetraacetic acid (EDTA), sorbic acid, ascorbates, benzoates, nitrates, nitrites, polyphosphates, propionates, sorbates, sulfites and tocopherol. According to certain embodiments, for “clean label” products sodium salt may be used as the sole preservative for the fat delivery system.

The method for preparing the fat delivery systems includes emulsifying as least one fat, at least partially gelling a carbohydrate such as an edible starch, and at least partially encapsulating the at least one emulsified fat with the at least partially gelled starch. The method for preparing the fat delivery systems includes emulsifying as least one fat, at least partially gelling an edible starch, and substantially encapsulating the at least one emulsified fat with the at least partially gelled starch. The method for preparing the fat delivery systems includes emulsifying as least one fat, at least partially gelling an edible starch, and fully encapsulating the at least one emulsified fat with the at least partially gelled starch.

The method for preparing the fat delivery systems includes emulsifying as least one fat, substantially gelling a carbohydrate such as an edible starch, and at least partially encapsulating the at least one emulsified fat with the at least partially gelled starch. The method for preparing the fat delivery systems includes emulsifying as least one fat, substantially gelling an edible starch, and substantially encapsulating the at least one emulsified fat with the at least partially gelled starch. The method for preparing the fat delivery systems includes emulsifying as least one fat, substantially gelling an edible starch, and fully encapsulating the at least one emulsified fat with the at least partially gelled starch.

The method for preparing the fat delivery systems includes emulsifying as least one fat, fully gelling a carbohydrate such as an edible starch, and at least partially encapsulating the at least one emulsified fat with the at least partially gelled starch. The method for preparing the fat delivery systems includes emulsifying as least one fat, fully gelling an edible starch, and substantially encapsulating the at least one emulsified fat with the at least partially gelled starch. The method for preparing the fat delivery systems includes emulsifying as least one fat, fully gelling an edible starch, and fully encapsulating the at least one emulsified fat with the at least partially gelled starch.

According to certain embodiments, the method for preparing the fat delivery systems comprises combining together at least one fat and water with suitable emulsifier for the fat in an amount effective to emulsify the fat and to form a fat-in-water emulsion. At least one matrix material is added to the fat-in-water emulsion. The matrix material is at least partially gelled prior to or subsequent to adding it to the emulsion. A solid form, for example, solid particles, of the fat delivery system is formed by cooling the fat-in-water emulsion containing the gelled matrix material. According to the method, the emulsified fat is at least partially encapsulated or otherwise entrapped within the gelled matrix material. According to some embodiments of the method, the emulsified fat is partially encapsulated within or surrounded by the gelled matrix material. According to some embodiments of the method, the emulsified fat is completely encapsulated within the gelled matrix material.

The method for preparing the fat delivery systems may comprise combining together at least one fat and water with suitable emulsifier for the fat in an amount effective to emulsify the fat and to form a fat-in-water emulsion. At least one gellable starch matrix material is added to the fat-in-water emulsion. The starch matrix material is at least partially gelled prior to or subsequent to adding it to the emulsion. A solid form, for example, solid particles, of the fat delivery system is formed by cooling the fat-in-water emulsion containing the gelled starch matrix material. According to the method, the emulsified fat is at least partially encapsulated or otherwise surrounded by the gelled starch matrix material. According to some embodiments of the method, the emulsified fat is partially encapsulated within or entrapped in the gelled starch matrix material. According to some embodiments of the method, the emulsified fat is completely encapsulated within the gelled starch matrix material.

According to other embodiments, the method for preparing a fat delivery system comprises heating at least one non-animal fat to prepare a molten fat. A carbohydrate matrix material such as an edible starch is mixed with the heated non-animal fat to form a mixture of fat and starch. A suitable amount of water is added to the mixture of heated fat and starch to form an emulsion. The emulsion is heated by direct steam injection to at least partially gel the at least one starch in the emulsion. According to certain embodiments, the emulsion is heated by directed steam impingement under pressure, for example, with an in-line jet cooker. Other suitable methods of heating may include heating by extrusion, microwave heating, indirect heating with a double jacket vessel and the like. The emulsion containing the gelatinized starch is cooled to a sufficient temperature to form a solid fat delivery system. According to the method, the emulsified fat is at least partially encapsulated or otherwise entrapped within the gelled starch matrix material. According to some embodiments of the method, the emulsified fat is partially encapsulated within or entrapped in the gelled starch matrix material. According to some embodiments of the method, the emulsified fat is completely encapsulated within the gelled starch matrix material. According to further embodiments, additional components can be added to the mixture of heated fat and starch prior to the addition of the water to the mixture or the heating by direct steam injection. These additional components may include at least one emulsifier, at least one preservative, at least one tastant and combinations thereof.

According to the method of preparing the fat delivery systems, a suitable amount of at least one emulsifier for the fat is added to the combination of the at least one fat and water to emulsify the fat and to create a fat/oil-in-water emulsion. For purposes of this disclosure, an emulsifier is any substance that includes a hydrophilic (ie, at least partially water soluble) portion and a hydrophobic (ie, lipophilic) portion, and is capable of lowering or otherwise reducing the surface tension between the normally immiscible fat and water to create a fat/oil-in-water emulsion or to create a water-in-fat/oil emulsion. Any emulsifier that is generally regarded as safe for inclusion in an edible food product that is intended for human or pet consumption, and that is capable of emulsifying the fat to create the emulsion, may be used as an emulsifier for preparing the disclosed fat delivery systems.

The emulsifiers may be anionic emulsifiers, cationic emulsifiers, non-ionic emulsifiers and amphoteric emulsifiers. According to certain embodiments, and without limitation, the emulsifiers having an HLB value of 1 to 18 may be used to prepare the fat delivery systems. Without limitation, and only by way of illustration, suitable fat emulsifiers include celluloses, monoglycerides, diglycerides, acylated monoglycerides, lactylated monoglycerides succinylated monoglycerides, alkoxylated monoglycerides (such as ethoxylated monoglycerides), alkoxylated diglycerides (such as ethoxylated diglycerides), esters of monoglycerides (such as diacetyl tartaric acid esters of monoglycerides), lethicins (such as soy lecithin and lecithin from egg yolk), succinic acid modified starches, gum Arabic, succinic acid modified gum Arabic, Quillaya saponins, magnesium stearate, calcium, potassium and sodium salts of fatty acids, polysorbates, alkali metal stearoyl lactylate (such as sodium stearoyl lactylate), sugar esters, alkaline earth metal stearoyl lactylate (such as calcium stearoyl lactylate), sodium phosphates, proteins, and mixtures thereof. According to certain illustrative embodiments, the emulsifier may comprise a lecithin. According to certain illustrative embodiments, the emulsifier may comprise a soy-based lecithin. According to certain illustrative embodiments, the emulsifier may comprise a modified corn starch. According to certain illustrative embodiments, the emulsifier may comprise an organic acid-modified corn starch. Without limitation, a suitable succinic acid modified corn starch that may be used as the emulsifier in accordance with the present disclosure is commercially available from Ingredion (Westchester, Ill., US) under the trade designation CAPSUL.

The emulsifier may be added to a mixture of fat and water in an amount from about 0.5 to about 10 weight percent, based on the total weight of the emulsifier, the at least one fat and water, to create the emulsion. According to other embodiments, the emulsifier may be added to a mixture of fat and water in an amount from about 2 to about 8 weight percent, based on the total weight of the emulsifier, the at least one fat and water, to create the emulsion, or from about 2 to about 5 weight percent, based on the total weight of the emulsifier, the at least one fat and water, to create the emulsion.

The at least one fat and food grade aqueous liquid, medium, or solvent, such as water, are combined to form emulsion created by suitable dispersing or homogenizing equipment. Without limitation, suitable homogenizing equipment includes rotor-stator homogenizers, bead mill homogenizers, ultrasonic homogenizers, high pressure homogenizers, and the like. According to certain illustrative embodiments, a rotor-stator type homogenizer is used to form the emulsion from the combination of the fat and aqueous liquid. Such equipment is commercially available from Bee International, Benchmark Scientific, Bertin, BioLogics, BioSpec, Branson, DyHydromatics, Glen Mills, IKA Werke, Interscience, Nex Advance, Ohaus, Pro Scientific, Qsonica, Scilogex, and Seward. A suitable rotor-stator type disperser/homogenizer is commercially available under the trade designation ULTRA-TURRAX® T 50 from Ika Werke (Staufen, Germany). The step of emulsifying the fat component to prepare a fat/oil-in-water emulsion may be carried about at a temperature in the range of about 10 to about 95° C. for about 1 to about 2 minutes, and using a rotor-stator type homogenizer at a circumferential speed of about 10,000 RPM. According to certain embodiments, the temperature may be in the range of about 40 to about 60° C. for the disclosed period of time.

Native starch granules are partially crystalline and highly organized due to the bonding of the amylose and amylopectin units in the larger starch molecule. The terms “gelation,” “gellable,” “gelling,” “gelatinize,” “gelatinizing,” or “gelatinization” may be used interchangeably throughout the present Specification and refer to the same process of breaking down the intermolecular bonds within the starch molecule to expose hydrogen bonding sites on the starch molecule to more water. This process causes the starch granules to swell and irreversibly lose their crystalline structure, become amorphous, and finally dissolve. According to certain embodiments, the process of gelling the starch may involve the breaking down of the intermolecular bonds within the starch molecule in the presence of water and applied heat. The type of starch determines the temperature range that the starch must be heated in the presence of water to begin the breakdown of the intermolecular bonds in the starch to start the starch swelling process. For unmodified starches, the breakdown of the intermolecular bonds and commencement of starch granule swelling (ie, gelling) may occur at or around about 55° C. For other types of starches, the breakdown of the intermolecular bonds and commencement of starch granule swelling may occur in the range of about 55 to about 90° C. The mixture of the fat/oil-in-water emulsion and the added starch may be heated in a temperature range of about 55 to about 120° C., or in temperature range of about 70 to about 90° C., or in a temperature range of about 75 to about 85° C. to gelatinize the starch component of the fat delivery system. According to other embodiments, the mixture of the fat/oil-in-water emulsion and the added starch may be heated in a temperature range of about 110° C. to about 120° C. by a direct steam injection process in order to gelatinize the starch component of the fat delivery system.

According to the method of preparing the fat delivery system, the step of partially gelling the at least one starch comprises heating the emulsion containing the at least one starch to at least partially gel the at least one starch added the emulsion of the fat and water. According other embodiments of the method of preparing the fat delivery system, the step of gelling the at least one starch comprises heating the emulsion containing the at least one starch to substantially gel the at least one starch added to the emulsion of the fat and water. According other embodiments of the method of preparing the fat delivery system, the step of gelling the at least one starch comprises heating the emulsion containing the at least one starch to fully gelling the at least one starch added to the emulsion of the fat and water. The gelling of the at least starch results in the gelatinized and dissolved starch at least partially coating, covering, otherwise encapsulating, or entrapping the droplets of the fat/oil-in-water emulsion.

The size distribution of the droplets of fat/oil-in-water emulsion may be in the range of about 0.1 micron to about 600 microns, about 0.1 micron to about 500 microns, about 0.1 micron to about 400 microns, about 0.1 micron to about 300 microns, about 0.1 micron to about 200 microns, about 0.1 to about 100 microns, about 0.1 micron to about 50 microns, or from about 0.1 micron to about 25 microns, about 0.1 micron to about 20 microns, about 0.1 micron to about 15 microns, about 0.1 micron to about 10 microns, or from about 1 micron to about 5 microns. According to certain embodiments, the size distribution of the droplets of fat/oil-in-water emulsion may be in the range of about 50 microns to about 600 microns, about 50 microns to about 500 microns, about 50 microns to about 400 microns, about 50 microns to about 300 microns, about 50 microns to about 200 microns, or about 50 microns to about 100 microns,

According to certain embodiments, hydrocolloids may be included to strengthen the particles of the fat delivery system in order to survive the mix in process and to control the temperature stability of the emulsion.

According to certain embodiments of the method of preparing a fat delivery system, the at least one carbohydrate matrix material such as an edible starch is dissolved in the emulsion prior to heating the emulsion and gelation of the starch material.

According to the method of preparing a fat delivery system, the step of forming the solid or semi-solid form food product comprises cooling the heated emulsion containing the gelled starch to form the solid or semi-solid form.

The method of making the fat delivery systems further comprises reducing the size of the initial solid or semi-solid form of the fat delivery systems prepared from the fat/oil-water emulsion and the gelled carbohydrate. According to certain embodiments, the step of reducing the size of the solid form includes mechanically breaking apart, comminuting, cracking, crushing, cutting, dividing, extruding, fracturing, grating, grinding, or splitting the initial larger solid form into a plurality of smaller-sized solid particles or powders. According to certain embodiments, the step of reducing the size of the solid form includes comminuting the solid form into a plurality of smaller-sized solid particles. There is no practical limitation on the size of the greatest dimension of the comminuted solid particles so long as the size of the particles do not adversely affect the mouthfeel or texture of the final meat analogue product. Without limitation, and only by way of illustration, the step of comminuting the solid form into smaller sized solid particles includes comminuting the solid particles to a size of about 0.01 cm to about 10 cm, or from about 1 cm to about 10 cm, or from about 1 cm to about 5 cm, or about 1 cm to about 3 cm, or from about 0.3 cm to about 0.6 cm in its greatest dimension.

According to other embodiments, solid particles of the fat delivery system may be prepared by spray chilling, dropping droplets in a liquid cryogen (eg, liquid nitrogen), or by chemical gelation.

According to the method of preparing a fat delivery system, at least one flavor agent or flavoring may be added to the emulsion of fat and water prior to adding the at least one starch to the emulsion. According to certain embodiments, the at least one flavor agent or flavoring may be added to the water phase prior to adding to the fat phase to create the emulsion. The at least one starch is then added to the emulsion.

Also disclosed is an edible food product. The edible food product may comprise a vegetarian or vegan food product. The food product may comprise a vegetarian or vegan meat analogue product. The food product is a solid or semi-solid food product may comprise an edible non-animal protein base and a plurality of fat delivery systems that are dispersed within the edible non-animal protein base. According to certain embodiments, the food product is a solid or semi-solid food that may comprise an edible plant-based protein base and a plurality of fat delivery systems that are dispersed within the edible plant-based protein base. The fat delivery systems that are dispersed within the non-animal protein base comprise delivery systems of an emulsified non-animal fat and gelled starchy material.

The amounts of the non-animal protein base and the fat delivery systems of the food product can be adjusted to provide the final meat analogue food product having the appearance, flavor and texture of certain types of real meat.

The non-animal derived protein base of the food product may include at least one plant-based or plant-derived protein. For example, and without limitation, the plant-derived protein may comprise algae (such as spirulina), beans (such as black beans, canelli beans, kidney beans, lentil beans, lima beans, pinto beans, soy beans, white beans, mung beans), broccoli, mycoprotein, nuts (such as almonds, brazil nuts, cashews, peanuts, pecans, hazelnuts, pine nuts, walnuts), peas (such as black eyed peas, chickpeas, green peas), potatoes, oatmeal, seeds (such as chia, flax, hemp, pumpkin, sesame, sunflower), plant leaf proteins such as Robisco, cereal (such as oatmeal, wheat, barley, spelt, corn, rice), seitain (ie, wheat gluten-based), tempeh, tofu, and mixtures thereof. According to certain embodiments, the plant-derived protein useful as the protein base of the food product is a potato-derived protein. Without limitation, a suitable potato protein is commercially available from Avebe under the trademark SOLANIC® (Veendam, The Netherlands).

Without limitation, and only by way of illustration, the food product comprises greater than 50 weight percent to about 99 weight percent of said edible protein base and from about 1 weight percent to less than 50 weight percent of said plurality of fat delivery systems, based on the total weight of the food product.

Without limitation, and only by way of illustration, the food product comprises greater than 50 weight percent to about 99 weight percent of said edible non-animal protein base and from about 1 weight percent to less than 50 weight percent of said plurality of fat delivery systems, based on the total weight of the food product.

Without limitation, and only by way of illustration, the food product comprises greater than 50 weight percent to about 99 weight percent of a hybrid protein base comprising both animal-derived protein and non-animal-derived protein, and from about 1 weight percent to less than 50 weight percent of said plurality of fat delivery systems, based on the total weight of the food product.

Without limitation, and only by way of illustration, the food product comprises greater than 50 weight percent to about 99 weight percent of a hybrid protein base comprising a blend of animal-derived protein and plant-derived protein, and from about 1 weight percent to less than 50 weight percent of said plurality of fat delivery systems, based on the total weight of the food product.

According to other illustrative embodiments, the food product comprises from about 60 weight percent to about 99 weight percent of said edible non-animal protein base and about 1 weight percent to about 40 weight percent of said plurality of fat delivery systems, based on the total weight of the food product.

According to other illustrative embodiments, the food product comprises from about 70 weight percent to about 99 weight percent of said edible non-animal protein base and about 1 weight percent to about 30 weight percent of said plurality of fat delivery systems, based on the total weight of the food product.

According to other illustrative embodiments, the food product comprises from about 75 weight percent to about 99 weight percent of said edible non-animal protein base and about 1 weight percent to about 25 weight percent of said plurality of fat delivery systems, based on the total weight of the food product.

According to other illustrative embodiments, the food product comprises from about 75 weight percent to about 95 weight percent of said edible non-animal protein base and about 5 weight percent to about 25 weight percent of said plurality of fat delivery systems, based on the total weight of the food product.

According to other illustrative embodiments, the food product comprises from about 75 weight percent to about 90 weight percent of said edible non-animal protein base and about 10 weight percent to about 25 weight percent of said plurality of fat delivery systems, based on the total weight of the food product.

According to other illustrative embodiments, the food product comprises from about 75 weight percent to about 85 weight percent of said edible non-animal protein base and about 15 weight percent to about 25 weight percent of said plurality of fat delivery systems, based on the total weight of the food product.

According to other illustrative embodiments, the food product comprises from about 90 weight percent to less than 100 weight percent of said edible non-animal protein base and greater than 0 weight percent to about 10 weight percent of said plurality of fat delivery systems, based on the total weight of the food product, or about 90 weight percent to less than 99 weight percent of said edible non-animal protein base and about 1 weight percent to about 10 weight percent of said plurality of fat delivery systems, based on the total weight of the food product, or about 90 weight percent to less than 98 weight percent of said edible non-animal protein base and about 2 weight percent to about 10 weight percent of said plurality of fat delivery systems, based on the total weight of the food product, or about 90 weight percent to less than 97 weight percent of said edible non-animal protein base and about 3 weight percent to about 10 weight percent of said plurality of fat delivery systems, based on the total weight of the food product, or about 90 weight percent to less than 96 weight percent of said edible non-animal protein base and about 4 weight percent to about 10 weight percent of said plurality of fat delivery systems, based on the total weight of the food product, or about 90 weight percent to less than 95 weight percent of said edible non-animal protein base and about 5 weight percent to about 10 weight percent of said plurality of fat delivery systems, based on the total weight of the food product, or about 90 weight percent to less than 94 weight percent of said edible non-animal protein base and about 6 weight percent to about 10 weight percent of said plurality of fat delivery systems, based on the total weight of the food product, or about 90 weight percent to less than 93 weight percent of said edible non-animal protein base and about 7 weight percent to about 10 weight percent of said plurality of fat delivery systems, based on the total weight of the food product, or about 90 weight percent to less than 92 weight percent of said edible non-animal protein base and about 8 weight percent to about 10 weight percent of said plurality of fat delivery systems, based on the total weight of the food product, or about 90 weight percent to less than 91 weight percent of said edible non-animal protein base and about 9 weight percent to about 10 weight percent of said plurality of fat delivery systems, based on the total weight of the food product.

Further discloses is a method for making a food product that contains an edible food base and a desired amount of the fat delivery system. The method may be for making a food product that is a hybrid food product containing a blend of animal-derived components and non-animal-derived components in the food base, and a plurality of the fat delivery systems dispersed in the food base. The method may include mixing together a protein base and a plurality of emulsified fat delivery systems together to form a mixture and forming the mixture into a solid or semi-solid form. The plurality of fat delivery systems dispersed in the protein base comprise solid particles of an emulsified fat at least partially encapsulated or entrapped within a gelled carbohydrate material that has been gelled during the method.

The method for making a food product may also be directed to making a food product that does not include any animal derived components, or that is substantially free of any animal derived components. The method may include mixing together an edible non-animal protein base and a plurality of emulsified fat delivery systems together to form a mixture and forming the mixture into a solid or semi-solid form. The plurality of fat delivery systems dispersed in the non-animal protein base comprise solid particles of an emulsified vegetable fat at least partially encapsulated or entrapped within the starch material that has been gelled during the method.

According to certain embodiments, disclosed is a method for making a vegetarian or vegan food product. According to other embodiments, disclosed is a method for making a vegetarian or vegan meat analogue product. The method for making the vegetarian or vegan food product comprises mixing together an edible plant-based protein base and a plurality of emulsified vegetable fat delivery systems together to form a mixture and forming the mixture into a solid or semi-solid form. The plurality of fat delivery systems dispersed in the plant-based protein base comprise solid particles of an emulsified vegetable fat and starch material that has been at least partially gelled during the method.

According to the method of making the food product, the step of mixing the protein base with the plurality of fat delivery systems to create the mixture comprises dispersing a plurality of the fat delivery systems comprising emulsified vegetable fat containing the gelled starchy material within the protein base.

According to the method of making the food product, the step of forming the mixture of the protein base, the plurality of fat delivery systems, and other food additives into a solid form comprises thermoplastically extruding the mixture of the protein base, the plurality of fat delivery systems, and any other food additives.

According to other embodiments, the edible food product may comprise a real meat product comprising real meat components such as real meat muscle, protein or tissue and a plurality of the fat delivery systems incorporated into the real meat.

According to other embodiments, the edible food product may comprise a hybrid food product comprising an edible base component containing a combination of real meat components, such as real meat muscle, protein or tissue, and a non-animal derived protein component, and a plurality of the fat delivery systems incorporated into the edible base.

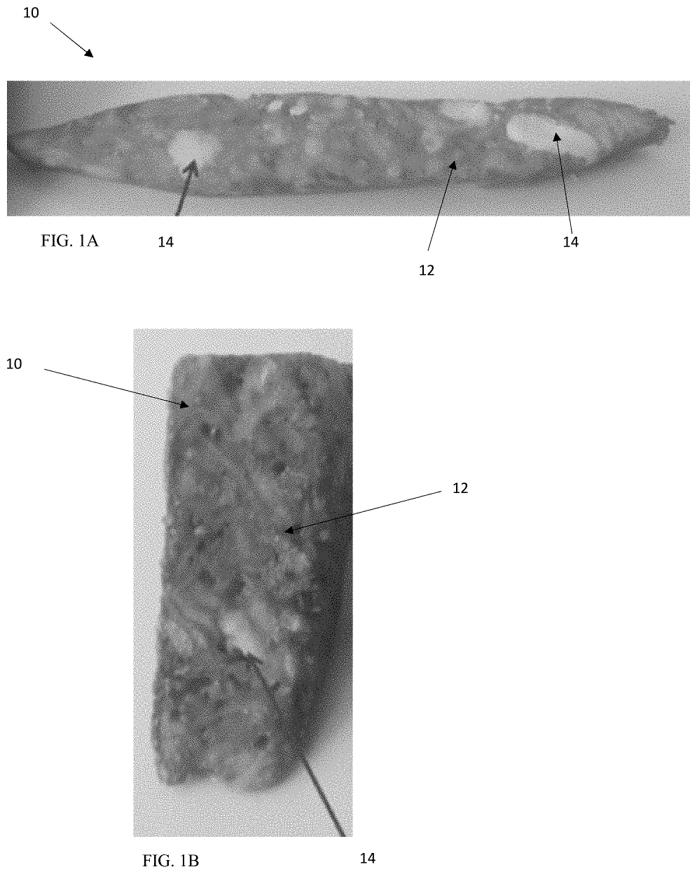

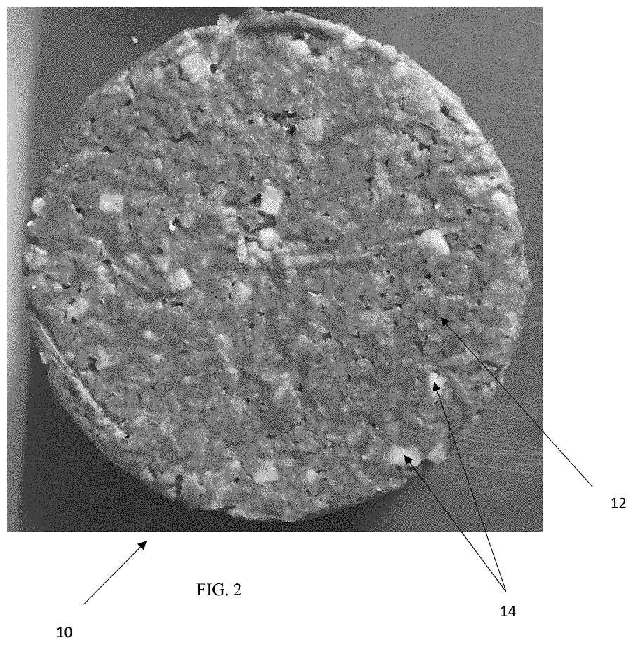

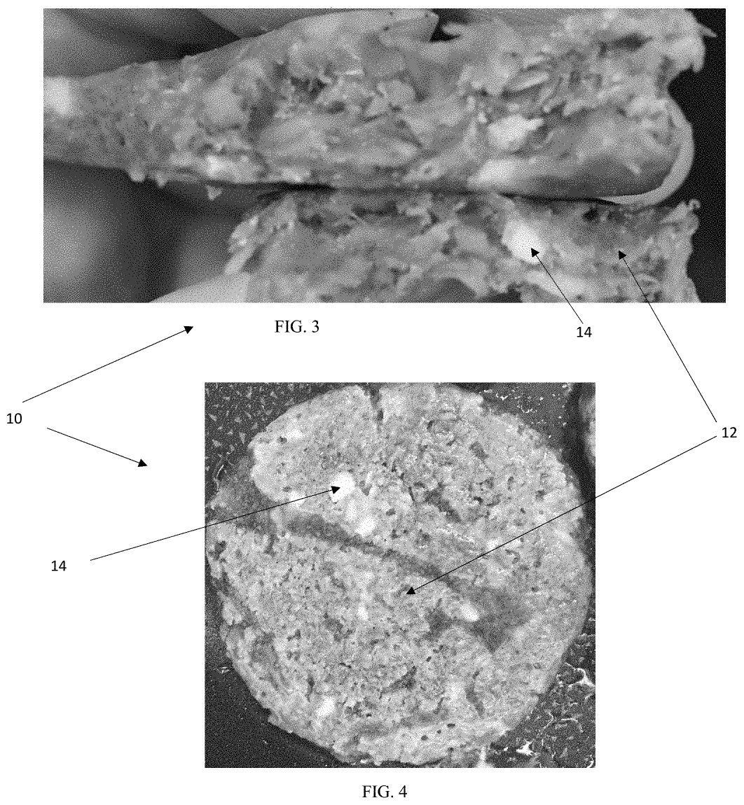

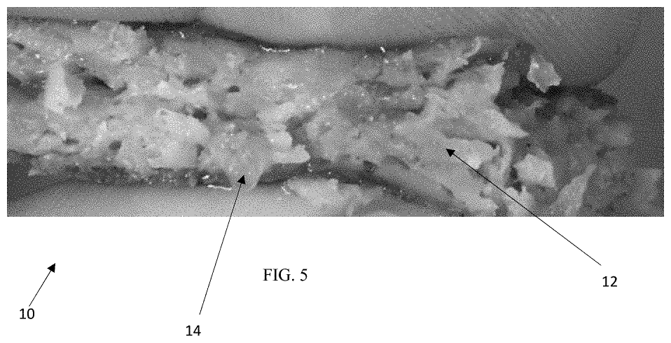

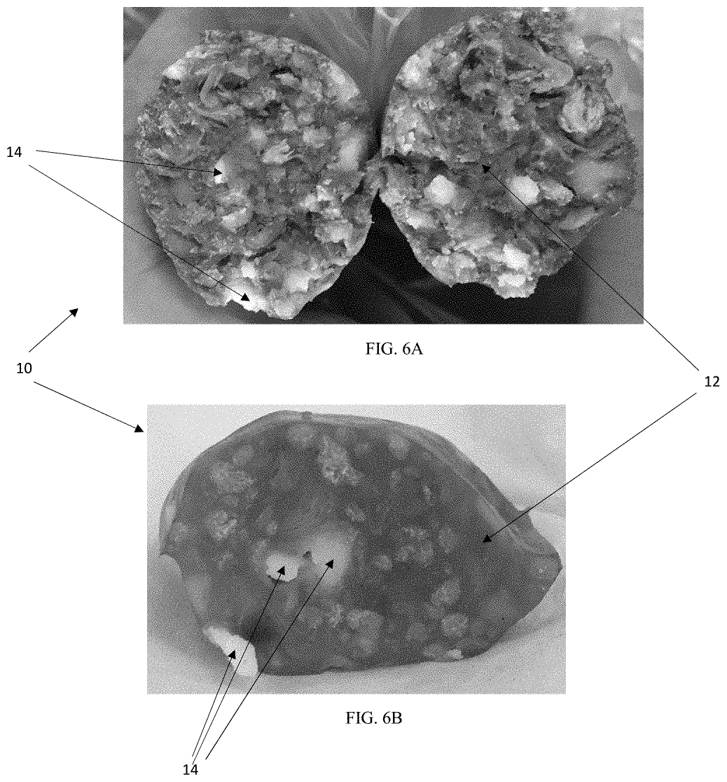

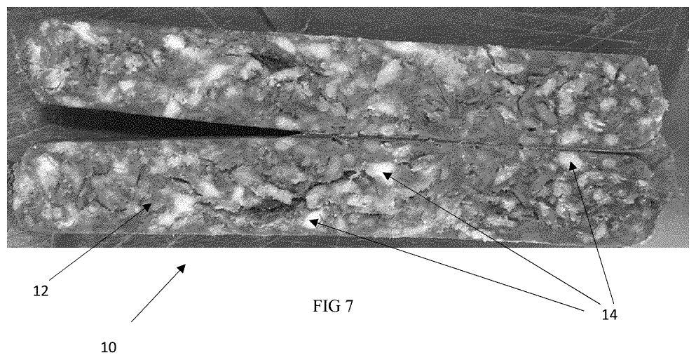

FIG. 1A shows an uncooked version of an illustrative embodiment of a food product of the present disclosure. FIG. 1B shows a cooked version of the illustration embodiment of a meat analogue of FIG. 1A. FIGS. 1A and 1B depict meat analogues 10 comprising plant-derived protein base 12 and fat delivery systems 14 dispersed within the protein based 12. FIGS. 2-5, 6A, 6B and 7 show various illustrative embodiments of the cooked and uncooked food products of the present disclosure, each of which contain a protein base 12 and fat delivery systems 14 in the base 12.

The fat delivery system can be used to prepare any product that is intended to be placed in the oral cavity and ingested, or to be used in the mouth and then discarded. Suitable consumable products include, but are not limited to, sauces, condiments, foodstuffs of all kinds, confectionery products, baked products, sweet products, savoury products (including the fake/meat analogue products, real meat products, and hybrid real meat/fake meat products), vegetable flavoured and vegetable products, dairy products, beverages, oral care products and combinations thereof.

The fat delivery system may be used to prepare a wide variety of non-animal based (for example, plant-based) consumable or otherwise edible food products, consumable or otherwise edible animal-based food products, and consumable or otherwise edible food products comprising a combination of animal-based components and non-animal based (for example plant-based) components. According certain illustrative embodiments, the fat delivery system may be used to prepare a wide variety of consumable or otherwise edible non-animal based meat analogue, meat replica, or meat substitute products. Suitable consumable or otherwise edible food products can be formulated, for example, without limitation, as hot dogs, burgers, ground meat, sausage links, sausage patties, steaks, filets, roasts, breasts, thighs, wings, meatballs, meatloaf, bacon, strips, fingers, nuggets, cutlets, and cubes.

According to certain embodiments, the consumable or edible food product comprises a non-animal based burger patty comprising a non-animal food base and the fat delivery system comprising a non-animal fat encapsulated within a gelled starch and dispersed within the non-animal food base. The consumable or edible food product may comprise a non-animal based burger patty comprising a plant-based protein base and the fat delivery system comprising a plant-based fat encapsulated within a gelled starch dispersed within the plant-based protein base. The consumable or edible food product may comprise a plant-based burger patty comprising a plant-based protein base and the fat delivery system comprising a plant-based fat encapsulated within a gelled starch dispersed within the plant-based food base. Without limitation, the plant-based protein base may comprise a textured vegetable protein that is combined with the fat delivery system. According to other embodiments, the burger patty may be a reduced animal-based burger patty where the food base comprises a mixture of animal-based protein and a textured vegetable protein as a replacement for a portion of the animal-based protein, in combination with the fat delivery system. According to further embodiments, the consumable or edible food product may comprise a plant-based burger patty comprising a plant-based protein base and the fat delivery system comprising a plant-based fat encapsulated within a gelled starch dispersed within the plant-based protein base. Without limitation, the plant-based protein base may comprise a textured vegetable protein combined with the fat delivery system. According to certain embodiments, the method for making a burger patty product comprises mixing together an edible plant-based protein base and a plurality of fat delivery systems together to form a mixture, wherein the fat delivery systems comprise solid particles of an emulsified fat at least partially encapsulated in a gelled starch, and forming the mixture into a burger patty.

According to other embodiments, a plant-based burger patty comprising the fat delivery system may be prepared by an additive manufacturing or 3D printing process. A digital image of a three-dimensional burger patty is created with 3D modeling computer software. The 3D model of the digital file is then sliced into many thin, 2 dimensional (2D) layers using slicing software and then converted into a set of instructions in machine readable language for the 3D printer to execute. The digital file with the set of instructions in machine readable code is communicated to the additive manufacturing equipment (ie, a 3D printer). The 3D printer prints a burger patty by laying down successive then layers of materials through one or more nozzles. According to certain embodiments, separate sources of the fat delivery system and the edible plant-based protein base of the burger patty are in communication with the 3D printer. The fat delivery system and the edible plant-derived protein base are stored in separate containers. Each of the containers are connected to one or more discharge nozzles via a suitable conduit extending between the containers and the nozzles. Upon executing the set of instructions, the 3D printer melts the fat delivery solid and the plant-derived protein base by moving these materials from the source containers though the conduits to the discharge nozzles. The materials are discharged from the nozzles to lay down successive layers of material to create a built-up 3-dimensional burger patty. According to other embodiments, the separate sources of the fat delivery system and the edible plant-based protein base may be moved via separate conduits to a mixing chamber where the fat delivery system is mixed with the protein base, and the mixture discharged from the mixing chamber to one or more discharge nozzles via one or more conduits extending between the mixing chamber and the one or more discharge nozzles. The mixture is then discharged from the one or more discharge nozzles to lay down successive thin, 2-dimensional layers until a 3-dimensional burger patty is formed. The solid fat delivery system can be provided in any form suitable for additive manufacturing or 3D printing processes. Without limitation, the fat delivery system solid may be provided in the form of particles, pellets, powders, blocks, filaments, rods, sticks, solid tubes, tapes, and the like, which can be melted and laid down in thin 2-dimensional layers with the edible plant-derived protein base.

A typical plant-based burger patty may be formed by blending together from about 1 to about 99 weight percent of a reconstituted textured vegetable protein and from about 99 weight percent to less than 1 weight percent of the fat delivery system. A typical plant-based burger patty may also be formed by blending together from about 50 to about 99 weight percent of a reconstituted textured vegetable protein and from about 1 weight percent to less than 50 weight percent of the fat delivery system. The textured vegetable protein is typically provided as a dehydrated product and can be reconstituted with water or another suitable cooking broth or consumable liquid. According to certain embodiments, about 90 weight percent of the reconstituted textured vegetable protein is blended with about 10 weight percent of the fat delivery system to prepare a suitable plant-based burger. The textured vegetable protein is usually ground to a smaller size prior to be blended with the fat delivery system. The fat delivery system is generally comminuted into small pieces for easy blending with the ground and reconstituted textured vegetable protein. The fat delivery system may also contain suitable flavours or spices to impart the desired taste to the plant-based burger. The reconstituted textured vegetable protein and fat delivery system are mixed together and then formed into suitable sized burger patties by hand, hand tool, or automated burger patty forming equipment.

According to certain embodiments, a bakery dough is provided that comprises the fat delivery system. A bakery dough includes a leavening agent, flour, and fat. In the case of sweet doughs, the dough includes sugar in addition to the leavening agent, flour and fat. Other optional bakery dough ingredients include coloring agents, flavoring agents and a texturizing agents.

The leavening agent is typically present in bakery dough an amount of about 0.1% to about 5% by weight. The flour content of the bakery dough is present in an amount of about 10% to about 60%. The fat component of the bakery dough may be present in an amount of about 5% to 35% by weight. For bakery dough that is not considered a sweet dough, the sugar content of the dough is typically 0.5 weight percent or less. According to some embodiments, of the bakery dough that is not a sweet dough, the dough is completely free of sugar. For sweet doughs, sugar or a sugar substitute is typically present in the sweet doughs in an amount of about 5% to 50%. If present, texturing agent may be selected from egg or egg white and may be present in an amount of about 1% to about 10% weight. Specific examples of suitable bakery doughs include, but are not limited to, muffins (e.g., English muffins), crackers (e.g., salted crackers, baked crackers, graham crackers, etc.), rolls (e.g., soft rolls, dinner rolls, crescent rolls), biscuits (e.g., buttermilk biscuits, cobbler biscuits), pie crusts, breads (e.g., focaccia, bruschetta, sourdough breads, soda breads, breadsticks, corn bread, etc.), pizza doughs, bagels, and the like, The sweet dough can be used to prepare, brownies, cookies, muffins, turnovers, doughnuts, cakes, pastries, pies, scones, and the like.

Without limitation, and only by way of illustration, exemplary dairy products include ice cream, impulse ice cream, ice cream desserts, frozen yoghurt, milk, fresh/pasteurized milk, full fat fresh/pasteurized milk, semi skimmed fresh/pasteurized milk, long-life/UHT milk, full fat long life/UHT milk, semi skimmed long life/UHT milk, fat-free long life/UHT milk, goat milk, condensed/evaporated milk, plain condensed/evaporated milk, flavoured, functional and other condensed milk, flavoured milk drinks, dairy only flavoured milk drinks, soy milk, sour milk drinks, fermented dairy drinks, coffee creamers/whiteners, powder milk, flavoured powder milk drinks, cream, yoghurt, plain/natural yoghurt, flavoured yoghurt, fruited yoghurt, probiotic yoghurt, yoghurt drinks, and other dairy-based desserts.

The fat delivery system may be used to prepared consumable savoury food products. Without limitation, and only by way of limitation, exemplary savoury food products include, salty snacks (potato chips, crisps, nuts, tortilla-tostada, pretzels, cheese snacks, corn snacks, potato-snacks, ready-to-eat popcorn, microwaveable popcorn, pork rinds, nuts, crackers, cracker snacks, breakfast cereals, meats, cured meats, luncheon/breakfast meats, tomato products, peanut butter, soups, canned vegetables, pasta sauces, and savoury biscuits, crackers and bread substitutes. The fat delivery system may also be used to prepare bakery and savoury fillings for food products.

The fat delivery system may be used to prepared consumable sweet food products. Without limitation, and only by way of illustration, sweet products include breakfast cereals, ready-to-eat (“rte”) cereals, family breakfast cereals, flakes, muesli, other rte cereals, children's breakfast cereals, and hot cereals.

The fat delivery system may be included in a single serving noodle bowl or noodle cup product. A single serving noodle bowl or noodle cup product typically includes an amount of precooked and dried noodles contained within a foam, paper or plastic container. The container also typically contains a packet of a dry flavoring and/or seasoned oil for the noodles. Alternatively, the dry flavoring may be provided as a loose powder within the container. The dried noodle product is prepared for consumption by soaking the noodles in boiling water to soften them, and combing the noodles the dry flavoring and/or seasoned oil. The single serving noodle product may comprise the precooked and dried noodles and a desired amount of the fat delivery systems. The fat delivery systems may be included in a separate package within the noodle bowl or cup, which is configured to be opened to release the fat delivery systems for combination with the noodles. The package containing the fat delivery systems may also include at least one flavoring additive. The package may also include a plurality of dehydrated food products, such as dehydrated vegetables. According to certain embodiments, the package contains a desired amount of the fat delivery system, at least one flavoring additive, and dehydrated vegetables. According to alternative embodiments, the fat delivery system may be provided as loose particles or powder within the noodle bowl or cup.

The fat delivery system may be used in personal care products such as pharmaceuticals, cosmetics and toiletries. When used within cosmetics and toiletries, the formulations can be used in any of the “Reported Product Categories” listed by the Cosmetic, Toiletries and Fragrance Association's ‘International Cosmetic Ingredient Dictionary and Handbook’, and with any one or more of the ingredients cited as being used for the reported product categories. The Reported Product Categories are: Aftershave lotions, Baby lotions, oils, powders and creams, Baby products miscellaneous, Baby shampoos, Basecoats and undercoats, Bath capsules, Bath oils, tablets and salts, Bath preparations miscellaneous, Bath soaps and detergents, Beard softeners, Blushers, Body and hand preparations, Bubble baths, Cleaning products, Colognes and toilet waters, Cuticle softeners, Dentifrices, Deodorants, Depilatories, Douches, Eye lotions, Eye makeup preparations miscellaneous, Eye makeup removers, Eye shadows, Eyebrow pencils, Eyeliners, Face and neck preparations, Face powders, Feminine hygiene deodorants, Foot powders and sprays, foundations, Fragrance preparations miscellaneous, Hair bleaches, Hair colour sprays, Hair colouring preparations miscellaneous, Hair conditioners, Hair dyes and colours, Hair lighteners with colour, Hair preparations, Hair rinses, Hair shampoos, Hair sprays, Hair straighteners, Hair tints, Hair wave sets, Indoor tanning preparations, Leg and body paints, Lipsticks, Makeup bases, Makeup fixatives, Makeup preparations, Manicuring preparations miscellaneous, Mascara, Men's talcum, Moisturising preparations, Mouthwashes and breath fresheners, Nail creams and lotions, Nail extenders, Nail polish and enamel removers, Nail polish and enamels, Night skin care preparations, Oral hygiene products miscellaneous, Paste masks, Perfumes, Permanent waves, Personal cleanliness products miscellaneous, Powders, Preshave lotions, Rouges, Sachets, Shampoos, Shaving cream, Shaving preparations miscellaneous, Shaving soap, Skin care preparations miscellaneous, Skin fresheners, Suntan gels, creams and liquids, Suntan preparations miscellaneous, Tonics, dressings and other hair grooming aids.

The fat delivery system may be used in oral care and oral hygiene products. “Oral care” or “oral hygiene” products may include any product that is applied to the oral cavity for the purposes of cleaning, freshening, healing, deodorising the oral cavity or any part thereof. Without limitation, and only by way of illustration, such oral care and oral hygiene compositions include, toothpastes, tooth gels, tooth powders, tooth whitening products, mouth rinses, mouthwashes, gargle compositions, lozenges, dental floss, tooth picks, anti-plaque and anti-gingivitis compositions, throat lozenges, throat drops, compositions for treatment of nasal symptoms, cold symptoms, and for cold relief.

According to certain embodiments, the fat delivery system may further comprise nutritionally effective amounts of at least one vitamin, at least one mineral, or a combination of at least one vitamin and at least one mineral. According to certain embodiments, the fat delivery system comprises a nutritionally effective amount of at least one vitamin. According to certain embodiments, the fat delivery system comprises a nutritionally effective amount of more than one different vitamin. According to certain embodiments, the fat delivery system comprises a nutritionally effective amount of at least one mineral. According to certain embodiments, the fat delivery system comprises a nutritionally effective amount of more than one different mineral. According to certain embodiments, the fat delivery system comprises a nutritionally effective amounts of at least one vitamin and at least one mineral.

### EXAMPLES

### Example 1

A sample of an illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 50° C. was added to the water solution. This mixture was homogenized with an Ultra Turrax mixer to create an oil-in-water emulsion. The emulsion was transferred to a Stephan mixer. 270 grams of Etenia QS starch and 15.5 grams of agar agar was added to the emulsion and was mixed in the temperature range of from 48° C. to 73° C. for 5 minutes to gel the starch. The gelled mixture was poured out from the mixer and transferred to a freezer to cool down the gelled mixture at −20° C. for about 30 minutes.

### Example 2

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 50° C. was added to the water solution. This mixture was homogenized with an Ultra Turrax mixer to create an oil-in-water emulsion. The emulsion was transferred to a Stephan mixer. 270 grams of Etenia QS starch, 15.5 grams of agar agar and 22 grams of Wagyu beef flavor was added to the emulsion and was mixed in the temperature range from 48° C. to 72.5° C. for 5 minutes to gel the starch. The gelled mixture was poured out from the mixer and transferred to a freezer to cool down the gelled mixture at −20° C. for about 30 minutes.

### Example 3

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 4. 270 grams of sunflower oil at a temperature of about 50° C. was added to the water solution. This mixture was homogenized with an Ultra Turrax mixer to create an oil-in-water emulsion. The emulsion was transferred to a Stephan mixer. 270 grams of Etenia QS starch and 15.5 grams of agar agar was added to the emulsion and was mixed from in a temperature range from 48° C. to 73° C. for 5 minutes to gel the starch. The gelled mixture was poured out from the mixer and transferred to a freezer to cool down the gelled mixture at −20° C. for about 30 minutes.

### Example 4

A sample of another embodiment of the presently disclosed fat delivery system was prepared. 2 grams of potassium sorbate and 0.5 grams of citric acid were added to 500 grams of water to prepare a solution having a temperature of 50° C. and pH of about 3.5 to about 4. 270 grams of sunflower oil at a temperature of about 50° C. and 12.5 grams of oat oil emulsifier were added to the water solution. This mixture was homogenized with an Ultra Turrax mixer to create an oil-in-water emulsion. The emulsion was transferred to a Stephan mixer. 270 grams of Etenia QS starch and 15.5 grams of agar agar was added to the emulsion and was mixed from 48° C. to 73° C. for 5 minutes to gel the starch. The gelled mixture was poured out from the mixer and transferred to a freezer to cool down the gelled mixture at −20° C. for about 30 minutes.

### Example 5

A sample of another illustrative embodiment of the presently disclosed fat delivery system was prepared. 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 50° C. and 12.5 grams of oat oil emulsifier were added to the water solution. This mixture was homogenized with an Ultra Turrax mixer to create an oil-in-water emulsion. The emulsion was transferred to a Stephan mixer. 270 grams of Etenia QS starch and 15.5 grams of agar agar was added to the emulsion and was mixed in a temperature range from 48° C. to 73° C. for 5 minutes to gel the starch. The gelled mixture was poured out from the mixer and transferred to a freezer to cool down the gelled mixture at −20° C. for about 30 minutes.

### Example 6

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 50° C. was added to the water solution. This mixture was homogenized with an Ultra Turrax mixer to create an oil-in-water emulsion. The emulsion was transferred to a Stephan mixer. 270 grams of Etenia QS starch 3 grams of Konjac polysaccharide gum, and 12 grams of xanthan gum were added to the emulsion and was mixed from in a temperature range of from 48° C. to 73° C. for 4 minutes to gel the starch. The gelled mixture was poured out from the mixer and transferred to a freezer to cool down the gelled mixture at −20° C. for about 30 minutes.

### Example 7

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 440 grams of melted Coberine fat at a temperature of about 50° C. was added to the water solution. This mixture was homogenized with an Ultra Turrax mixer to create an oil-in-water emulsion. The emulsion was transferred to a Stephan mixer. 270 grams of Etenia QS starch 3 grams of Konjac polysaccharide gum, and 12 grams of xanthan gum were added to the emulsion and was mixed in a temperature range from 48° C. to 74° C. for 4 minutes to gel the starch. The gelled mixture was poured out from the mixer and transferred to a freezer to cool down the gelled mixture at −20° C. for about 30 minutes.

### Example 8

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 50° C. was added to the water solution. This mixture was homogenized with an Ultra Turrax mixer to create an oil-in-water emulsion. The emulsion was transferred to a Stephan mixer. 270 grams of Etenia 457 starch and 15.5 grams of agar agar was added to the emulsion and was mixed in a temperature range from 48° C. to 73° C. for 4 minutes to gel the starch. The gelled mixture was poured out from the mixer and transferred to a freezer to cool down the gelled mixture at −20° C. for about 30 minutes.

### Example 9

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 55° C. was added to the water solution. This mixture was homogenized with an Ultra Turrax mixer to create an oil-in-water emulsion. The emulsion was transferred to a Stephan mixer. 270 grams of Etenia 457 starch and 15.5 grams of bovine-derived gelatin (250 Bloom) was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

### Example 10

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 55° C. was added to the water solution. This mixture was homogenized with an Ultra Turrax mixer to create an oil-in-water emulsion. The emulsion was transferred to a Stephan mixer. 270 grams of Perfectamyl VF starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

### Example 11

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 4. 270 grams of melted Cocos fat at a temperature of about 55° C. was added to the water solution. This mixture was homogenized with an Ultra Turrax mixer to create an oil-in-water emulsion. The emulsion was transferred to a Stephan mixer. 270 grams of Etenia 457starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

### Example 12

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Cocos fat at a temperature of about 55° C. was added to the water solution. This mixture was homogenized with an Ultra Turrax mixer to create an oil-in-water emulsion. The emulsion was transferred to a Stephan mixer. 270 grams of Perfetamyl VF starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

### Flavor Stability Testing

The flavor stability of the presently disclosed fat delivery system was measured by a Flavor Stability Test. Samples of the fat delivery system were prepared in accordance with the present disclosure and were stored in plastic containers in a refrigerator at 7° C. for six weeks. Week 0 is set at 100% and the flavor stability of the samples are measured in relation to the Week. Samples are removed from the refrigerator once per week from Week 1 through Week 6 and measured for flavor stability. Samples of the fat delivery system were removed from the refrigerator, crushed and homogenized in liquid nitrogen. 2 grams of the crushed and homogenized sample were mixed with 10 ml of acetone and 0.5 mg of an internal standard and shaken for 2 hours. The samples are filtered and analyzed by Gas Chromatography-Mass Spectrometry using Flame Ionization Detector to identify the presence of different flavor components in the test sample. The standard deviation for the Flavor Stability Test is in the range of ±10-15%.

### Example 13—Sulphur Test

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 55° C. and technical Sulphur flavour was added to the water solution. This mixture was homogenized with an Ultra Turrax mixer to create an oil-in-water emulsion. The emulsion was transferred to a Stephan mixer. 270 grams of Etenia 457 starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

The flavor stability of the sample fat delivery system of Example 13 was measured with respect to a model flavor block containing sulphur flavor components, in accordance with the Flavor Stability Test described hereinabove. After 6 weeks, the sample retained 96% methional, 70% cis-2-methyltetrahydrofuran-3-thiol, and trans-2-methyltetrahydrofuran-3-thiol.

### Example 14—Aldehyde Test

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 55° C. and technical aldehyde flavour was added to the water solution. This mixture was homogenized with an Ultra Turrax mixer to create an oil-in-water emulsion. 270 grams of Etenia 457 starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

The flavor stability of the sample fat delivery system of Example 14 was measured with respect to a model flavor block containing aldehyde flavor components, in accordance with the Flavor Stability Test described hereinabove. After 6 weeks, the sample retained 88% decanal, 79%, 2,4-decadienal, 79% octanal, and 67% hexanal.

### Example 15—Pyrazine Test

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 55° C. and technical pyrazine flavour was added to the water solution. This mixture was homogenized with an Ultra Turrax mixer to create an oil-in-water emulsion. 270 grams of Etenia 457 starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

The flavor stability of the sample fat delivery system of Example 15 was measured with respect to a model flavor block containing pyrazine flavor components, in accordance with the Flavor Stability Test described hereinabove. After 6 weeks, 97% acetyl thiazole, 97% ethyl-3-dimethyl-2 pyrazine, 96% trimethyl pyrazine, 90% acetoin natural and 77% acetyl propionyl.

### Example 16—Lacton Test

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 55° C. and technical lacton flavour was added to the water solution. This mixture was homogenized with an Ultra Turrax mixer to create an oil-in-water emulsion. The emulsion was transferred to a Stephan mixer. 270 grams of Etenia 457 starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

The flavor stability of the sample fat delivery system of Example 16 was measured with respect to a model flavor block containing lacton flavor components, in accordance with the Flavor Stability Test described hereinabove. After 6 weeks, the sample retained 98% decalacton gamma, 98% hexalacton gamma, 96% butyro 1, 4-lactone, and 86% dodecalacton delta.

### Example 17—Acid Test

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 55° C. and technical acid flavour was added to the water solution. This mixture was with homogenized with an Ultra Turrax mixer to create an oil-in-water emulsion. The emulsion was transferred to a Stephan mixer. 270 grams of Etenia 457 starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

The flavor stability of the sample fat delivery system of Example 17 was measured with respect to a model flavor block containing acid flavor components, in accordance with the Flavor Stability Test described hereinabove. After 6 weeks, the sample retained 95% decanoic acid, 94% octanoic acid, 93% hexanoic acid, and 93% butyric acid.

### Example 18—Alcohol Test

A sample of another illustrative embodiment of the presently disclosed fat delivery system was prepared. 50 grams of Capsul modified food starch, 2 grams of potassium sorbate and 0.5 grams of citric acid were added to 500 grams of water to prepare a solution having a temperature of 50° C. and pH of about 3.5 to about 4. 270 grams of melted Coberine fat at a temperature of about 55° C. and technical alcohol flavour was added to the water solution. This mixture was homogenized with an Ultra Turrax mixer to create an oil-in-water emulsion. The emulsion was transferred to a Stephan mixer. 270 grams of Etenia 457 starch and 15.5 grams of agar agar was added to the emulsion and was mixed in a temperature range from 48° C. to 75° C. for about 4 minutes to gel the starch. The gelled mixture was poured out from the mixer and transferred to a freezer to cool down the gelled mixture at −20° C. for about 30 minutes.

The flavor stability of the sample fat delivery system of Example 18 was measured with respect to a model flavor block containing alcohol flavor components, in accordance with the Flavor Stability Test described hereinabove. After 6 weeks, the sample retained 100% decanol, 98% octanol and 89% hexanol.

### Example 19

A sample of another illustrative embodiment of the presently disclosed fat delivery system was prepared. In the bowl of a Stephan mixer, 3046 grams of solid coconut fat was melted by heating to a temperature of about 55° C. and 250 grams of a liquid beef top note flavoring was added. 3046 grams of Etenia starch, 564 grams of Capsul modified food starch, 169 grams of agar agar, 12.5 grams of potassium sorbate and 19 grams of citric acid were blended into the melted coconut fat to create a mixture of ingredients. 4341 grams of cold water was added to the mixture and the bowl of the mixer was sealed to create a closed system. The mixture was heated with direct stream until the mixture reached a temperature of about 110° C. After about 6-7 minutes gelatinization of the starch in the mixture occurred. The heating was stopped and the mixture was cooled to about 72° C. The gelled mixture was removed from the bowl of the Stephan mixer and transferred to a container for storage in a refrigerator at a temperature of about 2 to about 4° C. for about 48 hours.

### Example 20

A sample of another illustrative embodiment of the presently disclosed fat delivery system was prepared. In the bowl of a Stephan mixer, 3046 grams of solid coconut fat was melted by heating to a temperature of about 55° C. 3046 grams of Etenia starch, 564 grams of Capsul modified food starch, 169 grams of agar agar, 12.5 grams of potassium sorbate and 19 grams of citric acid were blended into the melted coconut fat to create a mixture of ingredients. 1250 grams of a spray dried Wagyu beef flavoring powder was added. 4341 grams of cold water was added to the mixture and the bowl of the mixer was sealed to create a closed system. The mixture was heated with direct stream until the mixture reached a temperature of about 110° C. After about 5-6 minutes gelatinization of the starch in the mixture occurred. The heating was stopped and the mixture was cooled to about 72° C. The gelled mixture was removed from the bowl of the Stephan mixer and transferred to a container for storage in a refrigerator at a temperature of about 2 to about 4° C. for about 48 hours.

### Example 21

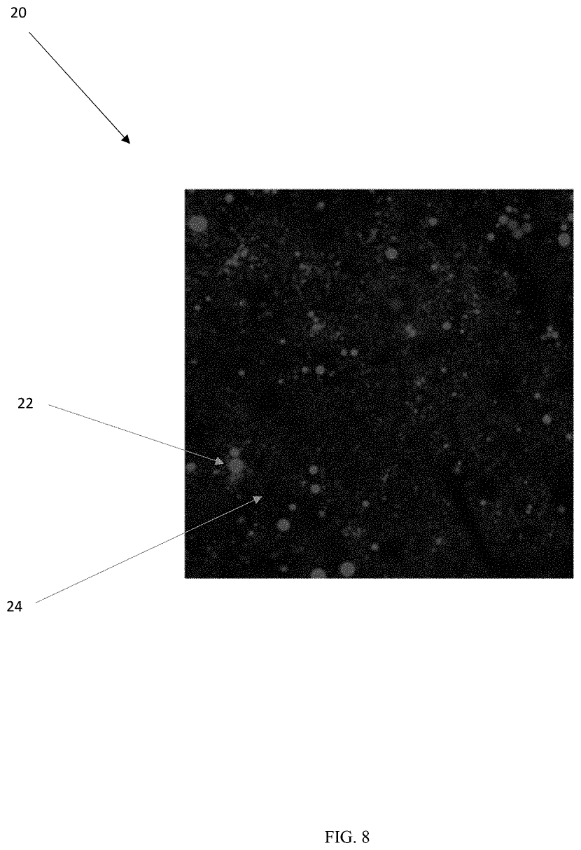

A sample of an illustrative embodiment of the presently disclosed fat delivery system was prepared. 9 kg of Capsul modified food starch, 0.08 kg of potassium sorbate and 0.8 kg of lemon juice (36% citric acid) were added to 89 kg of water to prepare a solution having a temperature of 80° C. and pH of about 3.5 to about 4. 48 kg of melted Coberine fat at a temperature of about 80° C. was added to the water solution to get a pre-emulsion by using a high speed stirrer. 48 kg of Etenia QS starch and 0.8 kg of agar agar were added to the pre-emulsion and were mixed in the temperature range of from 80° C. to 95° C. for 5 minutes to gel the starch. 3.3 kg beef flavour was added to the total mix and was mixed in the temperature range of −95° C. for 1 minute. This mixture was pumped by a positive displacement pump to an in-line homogenizer (rotor/stator, Silverson) to create an oil-in-water emulsion. This emulsion was poured out from a Silverson and transferred to a refrigerator to cool down the gelled mixture at 5° C. for about 24 hours to form a solid block. The solid block of the fat delivery system was analyzed by confocal scanning laser microscopy (CSLM) to identify and measure the size of the emulsified fat droplets within the solid block. FIG. 8 is a CSLM micrograph 20 showing a plurality of droplets of the fat delivery system 22 dispersed throughout the larger solid block 24.

### Example 22

A sample of another illustrative embodiment of the presently disclosed fat delivery system was prepared. In the bowl of a Stephan mixer, 500 grams of water, 44 grams of Capsul modified food starch, 301 grams of coconut oil and 24 grams of salt were blended to create an emulsion. 290 grams of Etenia starch was added to the emulsion and further blended with heat to gel the starch. 5 grams of agar agar was subsequently added to the emulsion and further blended. 24 grams of a spray dried Wagyu beef flavoring powder and 4.7 grams of lemon juice was added. After gelatinization of the starch in the mixture occurred, the heating was stopped and the mixture was cooled. The gelled mixture was removed from the bowl of the Stephan mixer and transferred to a container for storage in a refrigerator at a temperature of 5° C. to solidify the block.

### Example 23

A sample of another illustrative embodiment of the presently disclosed fat delivery system was prepared. In the bowl of a Stephan mixer, 3046 grams of solid coconut fat was melted by heating to a temperature of about 55° C. and 250 grams of a liquid beef top note flavoring was added. 3046 grams of Etenia starch, 564 grams of Capsul modified food starch, 169 grams of agar agar, 12.5 grams of potassium sorbate and 19 grams of citric acid were blended into the melted coconut fat to create a mixture of ingredients. 625 grams of a powder taste tastant was added. 4341 grams of cold water was added to the mixture and the bowl of the mixer was sealed to create a closed system. The mixture was heated with direct stream until the mixture reached a temperature of about 110° C. After about 6-7 minutes gelatinization of the starch in the mixture occurred. The heating was stopped and the mixture was cooled to about 72° C. The gelled mixture was removed from the bowl of the Stephan mixer and transferred to a container for storage in a refrigerator at a temperature of about 2 to about 4° C.

### Analysis of Cooked Plant-Based Burger

A plant-based burger was prepared from a dough comprising about weight percent of hydrated textured vegetable protein and about 10 weight percent of the presently disclosed plant-based fat delivery system. The fat delivery system was based on coconut fat. The plant-based burger was cooked and evaluated by a panel of trained food tasters. The plant-based burger was cooked fried in a standard stove-top frying pan. A suitable cooking oil was introduced into the frying pan and heat until hot. The plant-based burger was placed into the hot cooking oil and cooked for about 1 minute 30 seconds on one side. The plant-based burger was flipped and cooked from about 2 minutes 20 second on a second side. The plant-based burger was once again flip and cooked for an additional 1 minute 30 seconds on the first side, being careful not to burn the burger patty. The cooked burger patty was removed from the frying pan, cut into smaller sample size pieces, and placed on a heated dish or demonstration skillet. The results indicate that the plant-based burger exhibited good melting characteristics of the fat delivery system, a pleasant taste and smell, and an overall smooth, fatty mouthfeel.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

The compositional weight percentages disclosed herein are based on the total weight of the fat delivery systems or the food product, as the situation dictates. It will be understood to one of ordinary skill in the art that the total weight percent of the fat delivery systems or food product cannot exceed 100%. For example, a person of ordinary skill in the art would easily recognize and understand that a fat delivery system comprising 50 to 95 weight percent of a plant-based protein, 5 to 50 weight percent non-animal fat, and 1 to 10 weight percent further additives, such as flavour agents, will not exceed 100%. A person of ordinary skill in the art would understand that the amount of the components may be adjusted to include the desired amount of component without exceeding 100% by weight of the fat delivery system or food product.

While the fat delivery systems, the food products including the fat delivery systems, and methods of making the fat delivery systems and food products have been described in connection with various embodiments, it is to be understood that other similar embodiments may be used or modifications and additions may be made to the described embodiments for performing the same function. Furthermore, the various illustrative embodiments may be combined to produce the desired results. Therefore, the fat delivery systems, the food products including the fat delivery systems, and methods of making the fat delivery systems and food products should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A food product comprising:
an edible protein base; and
a plurality of fat delivery systems dispersed within said edible protein base, wherein the fat delivery systems comprises solid particles of an emulsified fat and gelled starch.

2. The food product of claim 1, wherein said food product comprises greater than 50 weight percent to about 99 weight percent of said edible protein base and from about 1 weight percent to less than 50 weight percent of said plurality of fat delivery systems.

3. The food product of claim 1, wherein said food product comprises from about 60 weight percent to about 99 weight percent of said edible protein base and about 1 weight percent to about 40 weight percent of said plurality of fat delivery systems.

4. The food product of claim 1, wherein said food product comprises from about 70 weight percent to about 99 weight percent of said edible protein base and about 1 weight percent to about 30 weight percent of said plurality of fat delivery systems.

5. The food product of claim 1, wherein said food product comprises from about 75 weight percent to about 99 weight percent of said edible protein base and about 1 weight percent to about 25 weight percent of said plurality of fat delivery systems.

6. The food product of claim 1, wherein said food product comprises from about 75 weight percent to about 95 weight percent of said edible protein base and about 5 weight percent to about 25 weight percent of said plurality of fat delivery systems.

7. The food product of claim 1, wherein said food product comprises from about 75 weight percent to about 90 weight percent of said edible protein base and about 10 weight percent to about 25 weight percent of said plurality of fat delivery systems.

8. The food of claim 1, wherein said food product comprises from about 75 weight percent to about 85 weight percent of said edible protein base and about 15 weight percent to about 25 weight percent of said plurality of fat delivery systems.

9. The food product of claim 1, wherein the fat delivery system comprises from about 5 weight percent to about 60 weight percent of an emulsified vegetable fat and from about 40 to about 95 weight percent of a gelled starch, based on the total weight of the fat delivery system.

10. The food product of claim 1, wherein the fat delivery system comprises from about 10 weight percent to about 60 weight percent of an emulsified vegetable fat and from about 40 to about 90 weight percent of a gelled starch, based on the total weight of the fat delivery system.

11. The food product of claim 1, wherein the fat delivery system comprises from about 20 weight percent to about 50 weight percent of an emulsified vegetable fat and from about 50 to about 80 weight percent of a gelled starch, based on the total weight of the fat delivery system.

12. The food product of claim 1, wherein the fat delivery system comprises from about 30 weight percent to about 40 weight percent of an emulsified vegetable fat and from about 60 to about 70 weight percent of a gelled starch, based on the total weight of the fat delivery system.

13. The food product of claim 1, wherein the fat delivery system comprise about 40 weight percent of an emulsified vegetable fat and about 60 weight percent of a gelled starch, based on the total weight of the fat delivery system.

14. The food product of claim 1, wherein said fat systems further comprise at least one flavour.

15. The food product of claim 1, wherein said food product is selected from the group consisting of hot dogs, burgers, ground meat, sausage links, sausage patties, meatballs, meatloaf, and nuggets.

16. The food product of claim 15, wherein said food product is a burger.

17. A method for preparing a fat delivery system comprising:
combining at least one fat and water with an emulsifier to form an emulsion;
adding at least one starch to the emulsion;
at least partially gel the at least one starch; and
forming a solid from the emulsion containing the gelled starch, wherein the gelled starch encapsulates the emulsion.

18. The method for preparing a fat delivery system of claim 17, further comprising comminuting the solid into particles.

19. The method for preparing a fat delivery system of claim 18, wherein said comminuting comprises comminuting the solid particles to a size of about 0.01 cm to about 10 cm.

20. The method for preparing a fat delivery system of claim 19, wherein said comminuting comprises comminuting the solid particles to a size of about 1 mm to about 3 mm.

21. The method of preparing a fat delivery system of claim 17, wherein the step of partially gelling the at least one starch comprises heating the emulsion containing the at least one starch to at least partially gel the at least one starch.

22. The method of preparing a fat delivery system of claim 17, wherein the step of forming the solid comprises cooling the heated emulsion containing the gelled starch to form the solid.

23. The method of preparing a fat delivery system of claim 17, further comprising adding at least one flavour, herbs, seasoning, spices, tastants, taste enhancers, or taste modifiers to the emulsion of fat and water prior to adding the at least one starch.

24. The method of preparing a fat delivery system of claim 17, further comprising dissolving the at least one starch prior to heating the emulsion.

25. A method for making a food product comprising:
mixing together an edible protein base and a plurality of emulsified fat delivery systems together to form a mixture, wherein the fat delivery systems comprise solid particles of an emulsified non-animal fat and gelled starch; and
forming the mixture into a solid.

26. The method of making a food product of claim 25, wherein the step of forming the mixture into a solid comprising extruding said mixture.

27. The method of claim 26, wherein the step of mixing comprises dispersing the emulsified fat delivery systems within said edible non-animal protein base.
